(19) United States
(12) Patent Application Publication
(10) Pub. No.: US 2006/0264601 A1
(43) Pub. Date: Nov. 23, 2006

(54) Method for production of alkylene oxide based polymer

(75) Inventors: Fumihide Tamura, Shiga (JP); Kazuo Takei, Osaka (JP); Teruki Matsushita, Osaka (JP); Taketo Toba, Hyogo (JP)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Nippon Shokubai Co., Ltd., Osaka (JP)

(21) Appl. No.: 11/436,052

(22) Filed: May 18, 2006

(30) Foreign Application Priority Data
May 20, 2005 (JP) 2005-147521
Apr. 6, 2006 (JP) 2006-105258

(51) Int. Cl. C08G 65/02

(52) U.S. Cl. 528/403; 528/409

(57) ABSTRACT

A method for the production of an alkylene oxide based polymer in which an alkylene oxide based polymer is obtained by allowing a monomer including one or two or more oxirane compound(s), which may have a substituent, as an essential raw material to be polymerized using a polymerization catalyst while agitating in a solvent. In this method for the production, the solvent includes one or two or more compound(s) selected from the group consisting of ketones, ketone derivatives, esters, ethers, nitrile compounds and organic halogen compounds.

This application claims priority on Patent Application No. 2005-147521 filed in JAPAN on May 20, 2005 and Patent Application No. 2006-105258 filed in JAPAN on Apr. 6, 2006, the entire contents of which are hereby incorporated by reference.

### BACKGROUND OF THE INVENTION

1. Field of the Invention

The present invention relates to a method for the production of an alkylene oxide based polymer. Specifically, the invention relates to a method for the production of an alkylene oxide based polymer which comprises carrying out ring-opening polymerization of a monomer including an oxirane compound which may have a substituent.

2. Description of the Related Art

Conventionally, ethylene oxide and a group of substituted oxirane compounds have been used as raw monomer materials of a variety of polymeric materials owing to their prosperous reactivities and superior industrial applicability. In addition, ethylene oxide based polymers such as ethylene oxide based copolymers obtained by carrying out polymerization of the aforementioned raw monomer material (for example, see Herman F. Mark, Norbert M. Bikales, Charles G. Overberger, Georg Menges ed., “Encyclopedia of Polymer science and engineering”, volume 6, (USA), Wiley Interscience, 1986, p. 225-322) have been used as a polymeric material in a very wide range of applications in polyurethane resins such as glues, adhesives, coating materials, sealing agents, elastomers, flooring materials and the like, as well as hard, soft or semi-hard polyurethane resins, and various functional materials such as surfactants, sanitary products, deinking agents, lubricating oils, hydraulic oils, polyelectrolytes, battery materials, flexographic printing plate materials, protective films of color filters, and the like.

In general, varying molecular weight is desired for polymeric materials depending on each of their various applications. Therefore, in an attempt to achieve the excellent physical properties and the like thereof, it is important how polymeric materials having a molecular weight to meet each of the various applications can be prepared in a state with less variance. Hence, also in the case in which an ethylene oxide based copolymer is used, it is necessary to control the molecular weight of the copolymer depending on each application. Accordingly, methods for the production and preparation techniques of the copolymer have been extremely important.

However, substituted oxirane compounds to be the raw monomer material of the ethylene oxide based polymer are apt to be accompanied by a chain transfer reaction in the polymerization, which may consequently result in problems of readily causing lowering of the molecular weight of the polymer. Therefore, it was very difficult to obtain an ethylene oxide based polymer having a desired molecular weight with favorable reproducibility.

Additionally, in sanitary products, and various functional materials such as flexographic printing plate materials and protective films of color filters and the like, which are the applications of the ethylene oxide based polymer, a casting method or a coating method may be employed in production step of the semi-manufactured product or final product. In these cases, a film or sheet having flexibility with less tack was obtained by separating an ethylene oxide based copolymer obtained by solution polymerization or precipitation polymerization (JP-A-2003-277496, JP-A-H05-17566, JP-A-H05-310908) once from the solvent to give the pellet or powder, followed by dissolving in an inexpensive volatile solvent having a low boiling point together with any of functional additives such as various organic compounds, organic metal compounds and the like, and then evaporating the solvent. In case that the inexpensive and volatile solvent having a low boiling point which may be used in the casting method or coating method can be used as the polymerization solvent, it can be directly used in the casting or coating. Hence, a method for the production that is economical with less environmental load can be provided by excluding the steps of: separating the alkylene oxide based polymer from the solvent; redissolving in the inexpensive and volatile solvent having a low boiling point; and the like.

However, it was very difficult to obtain an alkylene oxide based polymer, with favorable reproducibility, having physical properties that enable formation of a film or sheet having flexibility and less tack in a solvent having a low boiling point, being inexpensive, and capable of readily dissolving functional additives such as various organic compounds, organic metal compounds and the like.

### SUMMARY OF THE INVENTION

A problem to be solved by the present invention is, upon obtaining an alkylene oxide based polymer, to provide a method for the production enabling the alkylene oxide based polymer to be polymerized in a solvent having a low boiling point, being inexpensive, and capable of readily dissolving functional additives such as various organic compounds, organic metal compounds and the like.

In an aspect of the present invention, there is provided a method for the production of an alkylene oxide based polymer in a process for obtaining an alkylene oxide based polymer by allowing a monomer including one or two or more oxirane compound(s), which may have a substituent, as an essential raw material to be polymerized using a polymerization catalyst while agitating in a solvent, wherein: the solvent includes one or two or more compound(s) selected from the group consisting of ketones, ketone derivatives, esters, ethers, nitrile compounds and organic halogen compounds; and the polymerization catalyst has a polymerization activity toward alkylene oxide in the solvent.

The oxirane compound which may have a substituent is a compound represented by, for example, the following formula (1): 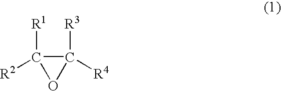
wherein, R¹, R², R³ and R⁴ each represent Ra (wherein Ra represents a hydrogen atom, an alkyl group having 1 to 20 carbon atoms, a cycloalkyl group having 1 to 20 carbon atoms, an aryl group having 1 to 20 carbon atoms, an aralkyl group having 1 to 20 carbon atoms, a (meth)acryloyl group having 1 to 20 carbon atoms, an alkenyl group having 1 to 20 carbon atoms or an alkaryl group having 1 to 20 carbon atoms; and two arbitrary substituents selected from the group consisting of R¹, R², R³ and R⁴ may form a ring together with the epoxy carbon atom to which it binds) or a —CH₂—O—Re—Ra group (wherein Re has a structure of —(CH₂—CH₂—O)p-, wherein p represents an integer of from 0 to 10). The epoxy carbon atom means a carbon atom constituting the oxirane ring. Also, R¹, R², R³ and R⁴ may be the same or different.

In the aforementioned method for the production, the polymerization catalyst is a catalyst having a polymerization activity toward alkylene oxide in the solvent (a solvent including one or two or more compound(s) selected from the group consisting of ketones, ketone derivatives, esters, ethers, nitrile compounds and organic halogen compounds). More preferably, the polymerization catalyst includes one or two or more compound(s) selected from the group consisting of from the following first group to fifth group, i.e., the first group: a group consisting of hydroxides of an element in group IA, alkoxy compounds of an element in group IA, and phenoxy compounds of an element in group IA; the second group: a group consisting of oxides of an element in group IA, group IIA, group IIB, group IVB or group VIII, and carboxylic acid salts of an element in group IA, group IIA, group IIB, group IVB or group VIII; the third group: a group consisting of compounds prepared by allowing a compound represented by R×M (wherein R represents a hydrocarbon group having 1 or more carbon atoms; M represents a metal having a Pauling's electronegativity of 0.5 to 3.0; and x represents the atomic valence of M) to react with a compound having one or more carbon atoms and having active hydrogen, and one or two or more compound(s) selected from the group consisting of water, phosphoric acid compounds, metal halide and Lewis bases; the fourth group: a group consisting of metal halides wherein the metal is Na, Be, Zr, Fe, Zn, Al, Ti, Sn, Ga or Sb; and the fifth group: a group consisting of onium salts of an element in group VB.

In the aforementioned method for the production, the polymerization catalyst includes one or two or more metal(s) selected from the group consisting of Al, Zn, Sn, P, alkali metals, Ga, Zr and Ti.

In the aforementioned method for the production, the solvent is preferably acetone.

In the aforementioned method for the production, it is preferred that the polymerization catalyst be charged successively.

According to the method for the production of an alkylene oxide based polymer of the present invention, polymerization to give the alkylene oxide based polymer can be perfected in a solvent having a low boiling point, being inexpensive, and capable of readily dissolving functional additives such as various organic compounds, organic metal compounds and the like.

### DESCRIPTION OF THE PREFERRED EMBODIMENTS

The method for the production of an alkylene oxide based polymer according to the present invention (hereinafter, may be also referred to as the method for the production of the present invention) will be explained in detail below, however, scope of the present invention is not limited thereto, but any modification can be made ad libitum without departing from the principles of the present invention, in addition to the following illustrative examples.

In the method for the production of the present invention, for obtaining an alkylene oxide based polymer, a monomer including an oxirane compound, which may have a substituent, as an essential raw material is allowed to be polymerized as a raw monomer material. Preferably, this oxirane compound which may have a substituent is a compound represented by the following formula (1): 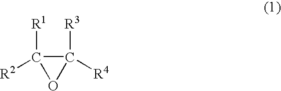
wherein, R¹, R², R³ and R⁴ each represent Ra (wherein Ra represents a hydrogen atom, an alkyl group having 1 to 20 carbon atoms, a cycloalkyl group having 1 to 20 carbon atoms, an aryl group having 1 to 20 carbon atoms, an aralkyl group having 1 to 20 carbon atoms, a (meth)acryloyl group having 1 to 20 carbon atoms, an alkenyl group having 1 to 20 carbon atoms or an alkaryl group having 1 to 20 carbon atoms; and two arbitrary substituents selected from the group consisting of R¹, R², R³ and R⁴ may form a ring together with the epoxy carbon atom to which it binds) or a —CH₂—O—Re—Ra group (wherein Re has a structure of —(CH₂—CH₂—O)p-, wherein p represents an integer of from 0 to 10). The epoxy carbon atom means a carbon atom constituting the oxirane ring. Also, R¹, R², R³ and R⁴ may be the same or different.

The alkylene oxide based polymer according to the present invention is preferably an ethylene oxide based copolymer. This ethylene oxide based copolymer is a polymer prepared by allowing a monomer mixture to be polymerized which includes as essential raw materials, for example, ethylene oxide, and a substituted oxirane compound represented by the following formula (2): 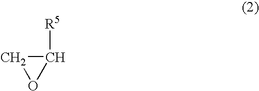
wherein, R⁵ is Ra (wherein Ra represents any one group of alkyl groups, cycloalkyl groups, aryl groups, aralkyl groups, (meth)acryloyl groups and alkenyl groups having 1 to 16 carbon atoms) or a —CH₂—O—Re—Ra group (wherein Re has a structure of —(CH₂—CH₂—O)p- wherein p represents an integer of from 0 to 10) as a raw monomer material.

The R⁵ group in the above formula (2) may be a substituent in the aforementioned substituted oxirane compound.

The substituted oxirane compound used as the raw monomer material may be either one substituted oxirane compound alone, which can be represented by the above formula (2), or that including two or more thereof. Furthermore, the raw monomer material according to the present invention may also be an oxirane compound which may have a substituent.

Examples of the substituted oxirane compound represented by the above formula (2) include e.g., propylene oxide, butylene oxide, 1,2-epoxypentane, 1,2-epoxyhexane, 1,2-epoxyoctane, cyclohexene oxide and styrene oxide, or methylglycidyl ether, ethylglycidyl ether, ethylene glycol methylglycidyl ether, and the like. Particularly, when the substituent R⁵ is a crosslinkable substituent, the examples include epoxybutene, 3,4-epoxy-1-pentene, 1,2-epoxy-5,9-cyclododecadiene, 3,4-epoxy-1-vinylcyclohexene, 1,2-epoxy-5-cyclooctene, glycidyl acrylate, glycidyl methacrylate, glycidyl sorbate and glycidyl-4-hexanoate, or, vinylglycidyl ether, allylglycidyl ether, 4-vinylcyclohexylglycidyl ether, α-terpenylglycidyl ether, cyclohexenylmethylglycidyl ether, 4-vinylbenzylglycidyl ether, 4-allyl benzylglycidyl ether, ethylene glycol allylglycidyl ether, ethylene glycol vinylglycidyl ether, diethylene glycol allylglycidyl ether, diethylene glycol vinylglycidyl ether, triethylene glycol allylglycidyl ether, triethylene glycol vinylglycidyl ether, oligoethylene glycol allylglycidyl ether, oligoethylene glycol vinylglycidyl ether and the like.

The monomer mixture used in the present invention may also include other monomer in addition to the aforementioned oxirane compound, which may have a substituent, as a raw monomer material. Moreover, the monomer mixture used in the present invention may include the alkylene oxide and the substituted oxirane compound as described above as raw monomer materials, and may further include other monomer.

In the case in which ethylene oxide and a substituted oxirane compound are selected as raw monomer materials, using amount of each of the ethylene oxide and substituted oxirane compound in the monomer mixture is not particularly limited, but may be arbitrarily set to fall within the range so that the resulting alkylene oxide based copolymer is prevented from having excessively lowered viscosity, and lacking in practical application performance. Additionally, when the substituted oxirane compound having a crosslinkable substituent is used, it may be used in an arbitrary ratio to total amount of the substituted oxirane compound, without any particular limitation.

Also in the case in which a monomer other than the aforementioned monomer is included in the monomer mixture, the using amount of each monomer may be similarly set taking into consideration of the resulting alkylene oxide based polymer.

Additionally, the alkylene oxide based polymer of the present invention preferably has physical properties enabling formation of a film or sheet having flexibility and less tack. In this respect, the present inventor elaborately carried out investigations. In the step, it occurred to the present inventor that control of several conditions employed in allowing for the polymerization reaction of the monomer to be the raw material may be important for obtaining with favorable reproducibility an alkylene oxide based polymer (particularly, ethylene oxide based copolymer) having physical properties that enable formation of a film or sheet having flexibility and less tack, and various experiments and investigations were performed.

The several conditions in the polymerization involve type of the polymerization solvent having a low boiling point, being inexpensive and capable of readily dissolving functional additives such as various organic compounds, organic metal compounds and the like; type of the polymerization catalyst; and combination thereof; combination of the monomers; and a variety of parameters to be set such as volume of the polymerization pot, total charging amount, agitation blade rotational frequency; agitation power, monomer feeding condition (monomer feeding rate), reaction temperature, pressure, and the like. Additionally, the present inventors found that type of the polymerization solvent in the polymerization, type of the polymerization catalyst, combination thereof, combination of the monomers, agitation power against contents in the reaction vessel (agitation power requirement per unit volume), and amount of the compound having active hydrogen and the like being present during the polymerization have greatly participated in obtaining with favorable reproducibility an alkylene oxide based polymer (particularly, ethylene oxide based copolymer) having physical properties that enable formation of a film or sheet having flexibility and less tack. Among them, in particular, by employing the adequate type of the polymerization solvent, adequate type of the polymerization catalyst, adequate combination thereof, and adequate combination of the monomers, it was found that the aforementioned problems could be solved once for all. Accordingly, preferred embodiment of the present invention was accomplished through identification of them.

In a suitable monomer which allows the ethylene oxide based copolymer according to the present invention to have properties that enable formation of a film or sheet having flexibility and less tack, it is preferred that the aforementioned substituted oxirane compound is, for example, butylene oxide, propylene oxide, or allylglycidyl ether. Moreover, with respect to proportion of the monomer in the ethylene oxide based copolymer, it is preferred that the ethylene oxide be 80 to 99% by mole, the butylene oxide alone or the propylene oxide alone, or mixture of the butylene oxide and the propylene oxide be 1 to 20% by mole, and the allylglycidyl ether be 0 to 2% by mole. Furthermore, with respect to the proportion of the monomer in the ethylene oxide based copolymer, it is more preferred that the ethylene oxide be 90 to 99% by mole, the butylene oxide be 1 to 10% by mole, and the allylglycidyl ether be 0 to 2% by mole. Further, with respect to the proportion of the monomer in the ethylene oxide based copolymer, it is even more preferred that the ethylene oxide be 92 to 97% by mole, the butylene oxide be 4 to 8% by mole, and the allylglycidyl ether be 0 to 2% by mole.

Upon obtaining the alkylene oxide based polymer in the method for the production of the present invention, polymerization may be allowed while the monomer mixture is agitated in a solvent.

The solvent may be one or two or more selected from the group consisting of ketones such as acetone, methyl ethyl ketone, methyl propyl ketone, methyl butyl ketone, diethyl ketone and ethyl butyl ketone; ketone derivatives such as ketal and acetal; ethers such as dimethyl ether, diethyl ether, dipropyl ether, methyl ethyl ether, ethyl butyl ether, dioxane and tetrahydrofuran; esters such as methyl acetate, ethyl acetate, propyl acetate, butyl acetate and methyl propionate; nitrile compounds such as methyl cyanide, ethyl cyanide, propyl cyanide, hexyl cyanide and butyl cyanide; organic halogen compounds such as methane chloride, methane dichloride, methane trichloride, methane tetrachloride, ethane chloride, ethane dichloride, ethane trichloride, ethane tetrachloride, ethane pentachloride, methane bromide, methane dibromide, methane tribromide, methane tetrabromide, ethane bromide, ethane dibromide, ethane tribromide, ethane tetrabromide and ethane pentabromide. The solvent without including active hydrogen such as an amino group, a carboxyl group, an alcohol group or the like is preferred. Among them, ketone and nitrile compounds are more preferred, and acetone and methyl cyanide are particularly preferred. Taking into account of solubility of the monomer, low boiling point and inexpensiveness overall, acetone is particularly preferred.

Among the aforementioned solvents, ketones are present in an equilibrium state with the corresponding enol that is a tautomer thereof. In other words, keto tautomer and enol tautomer form an equilibrium state in the ketones. The enol tautomer has a hydroxyl group. This hydroxyl group can lower the activity of the polymerization catalyst. Due to this lowering action of the catalytic activity, ketones were not conventionally used as the solvent for perfecting the polymerization to give the alkylene oxide based polymer. However, according to the present invention, polymerization of the alkylene oxide based polymer is enabled even in the case in which ketone (particularly acetone) is used as a polymerization solvent.

It is preferred that the solvent used in the present invention does not contain a compound having active hydrogen such as water at all. However, in general, the solvent often contains a compound having active hydrogen such as water which maybe in a slight amount as long as it is subjected to a removing treatment in a complete manner. As described later, in the method for the production of the present invention, it is preferred and important to control the amount of the compound having active hydrogen such as water included in the solvent to be not more than a certain amount.

In the method for the production of the present invention, an antioxidant, a solubilizing agent and the like which have been generally used so far may be further added for use in the polymerization although not particularly limited thereto.

The polymerization catalyst used in the present invention may be, for example, one or two or more compound(s) selected from the group consisting of from the following first group to fifth group, i.e., the first group: a group consisting of hydroxides of an element in group IA, alkoxy compounds of an element in group IA, and phenoxy compounds of an element in group IA; the second group: a group consisting of oxides of an element in group IA, group IIA, group IIB, group IVB or group VIII, and carboxylic acid salts of an element in group IA, group IIA, group IIB, group IVB or group VIII; the third group: a group consisting of compounds prepared by allowing a compound represented by R×M (wherein R represents a hydrocarbon group having 1 or more carbon atoms; M represents a metal having a Pauling's electronegativity of 0.5 to 3.0; and x represents the atomic valence of M) to react with a compound having one or more carbon atoms and having active hydrogen, and one or two or more compound(s) selected from the group consisting of water, phosphoric acid compounds, metal halide and Lewis bases; the fourth group: a group consisting of metal halides wherein the metal is Na, Be, Zr, Fe, Zn, Al, Ti, Sn, Ga or Sb; and the fifth group: a group consisting of onium salts of an element in group VB.

In the aforementioned first group, i.e., the group consisting of hydroxides of an element in group IA, alkoxy compounds of an element in group IA, and phenoxy compounds of an element in group IA, for example, KOH, alkoxy potassium, NaOH, R₃CONa, C₆H₅ONa and the like may be exemplified. In the aforementioned second group, i.e., the group consisting of oxides of an element in group IA, group IIA, group IIB, group IVB or group VIII, and carboxylic acid salts of an element in group IA, group IIA, group IIB, group IVB or group VIII, for example, SrO, CaO, ZnO, K acetate, Ca acetate, Ba acetate, acetic acid Mg, Cd acetate, Ni acetate, Co acetate, Mn acetate, Sr acetate, Cr acetate, Sn acetate, Zn acetate, Sn oxalate and the like may be exemplified. In the aforementioned third group, i.e., the group consisting of compounds prepared by allowing a compound represented by R×M (wherein R represents a hydrocarbon group having 1 or more carbon atoms; M represents a metal having a Pauling's electronegativity of 0.5 to 3.0; and x represents the atomic valence of M) to react with a compound having one or more carbon atoms and having active hydrogen, and one or two or more compound(s) selected from the group consisting of water, phosphoric acid compounds, metal halide and Lewis bases, for example, Ca(OR)₂, Ga(OR)₃, Ce(OR)₃, Zr(OR)₄, AlR₃/water, AlR₃/phosphoric acid, AlR₃/trialkylamine, aluminoxanes, AlR₃/Lewis base, AlR₃/H₂O/acetylacetone (acac), Vandenberg catalysts (wherein the Vandenberg catalyst represents a catalyst described in, for example, U.S. Pat. No. 3,219,591), Al(OR)₃, Al(OR)₃/primary amine, R₂AlOAlR₂, Al(OR)₃/ZnCl₂, Al(OR)₃/ZnR₂, Al(OR)₃/Zn(OCOCH₃)₂, R₃Al/Ni (dimethyl glyoxime)₂, AlR₃/succinimide/dioxane, ZnR₂/catechol, ZnR₂/halogenated benzoic acid, ZnR₂/pyrogallol, ZnR₂/resorcinol, ZnR₂/water, ZnR₂/phloroglucinol, ZnR₂/dihydricphenol, ZnR₂/ROH, ZnR₂/glycol, ZnR₂/glycol/alcohol, ZnR₂/t-RNH₂, R₂Zn/trialkylamine, (2,6-dichlorophenoxy)RZn, Zn (OR)₂, Zn(CH₂COCH₂COCH₃)₂, AlR₃/acac/ZnR₂, R₃SnCl/(RO)₃PO, immortal polymerization catalysts (wherein the immortal polymerization catalyst represents a catalyst described in, for example, JP-A-H04-323204), wherein R represents an alkyl group having 1 to 6 carbon atoms, a phenyl group, or a cycloalkyl group having 4 to 6 carbon atoms; and X/Y represents a polymerization catalyst prepared by allowing X and Y to react, and the like may be exemplified. In the aforementioned fourth group, i.e., the group consisting of metal halides wherein the metal is Na, Be, Zr, Fe, Zn, Al, Ti, Sn,Ga or Sb, for example, AlCl₃, AlCl₃/FeCl₃, AlCl₃/NaF, AlCl₃/alumina, AlCl₃/FeCl₃/substituted phenol, FeCl₃/Al(OH)₃, ZnCl₂, SnCl₄, SbF₅/diols, ZrCl₄, SbCl₅, BeCl₂, FeCl₃, Fe₃Cl₃, FeBr₃, TiCl₄GaCl₃ and the like may be exemplified. In the aforementioned fifth group, i.e., the group consisting of onium salts of an element in group VB, for example, tetraalkylammonium hydroxide, tetraalkylammonium chloride, tetraalkylphosphonium hydroxide, tetraalkylphosphonium chloride and the like may be exemplified. Particularly, the polymerization catalyst having a Ca, Al Zn or Sn metal is preferred. In particular AlR₃/phosphoric acid, AlR₃/trialkylamine, ZnR₂/ROH, ZnR₂/glycol, ZnR₂/glycol/alcohol, Zn(OR)₂Zn(CH₂COCH₂COCH₃)₂ and R₃SnCl/(RO)₃PO are more preferred. Examples of ZnR₂ include e.g., dimethylzinc, diethylzinc, di-n-propylzinc, di-i-propylzinc, dibutylzinc, diphenylzinc, dicyclobutylzinc and the like. Also, examples of Zn(OR)₂ include dimethoxyzinc, diethoxyzinc, di-i-propoxyzinc, dibutoxyzinc and the like. In the foregoing catalyst groups, the catalysts included in the catalyst groups selected from the aforementioned first group and third group are preferred because they exhibit a high catalytic activity in a solvent selected from the group consisting of ketones, ketone derivatives, esters, ethers, nitrile compounds and organic halogen compounds.

To these polymerization catalysts may be also added a clathrate compound such as cyclodextrin as well as crown ether, a chelating agent, alumina, silica, and a surfactant.

The polymerization catalyst can adjust the molecular weight of the resulting polymer by regulating the using amount thereof. The using amount is not particularly limited but may be determined ad libitum so that a desired molecular weight can be achieved. For example, the using amount may be set on the basis of the charging amount of the monomer mixture. Specifically, for example, when tert-butoxy potassium is used as the polymerization catalyst, the using amount thereof can be set such that 1 μmol or more tert-butoxy potassium is used per gram of the charging amount of the monomer mixture. Generally, in order to obtain a polymer having a high molecular weight, it is necessary to lower the using amount of the polymerization catalyst. However, too small using amount may result in inferior productivity due to extremely delayed progress of the polymerization reaction, or may hamper the progress of the polymerization reaction because the system becomes highly sensitized against contamination of a polymerization inhibitor being a compound having active hydrogen such as moisture in the reaction system. Additionally, in order to obtain a polymer having a high molecular weight, for example, it is important to regulate the using amount of the polymerization catalyst, and to eliminate impurities and polymerization inhibitory substances being the compound having active hydrogen such as moisture from the reaction system or to prevent the reaction system from causing the chain transfer reaction as described above.

The method of adding the polymerization catalyst is not particularly limited, but the using amount in its entirety may be charged previously together with the solvent before starting feeding of the monomer mixture to the solvent, or the polymerization catalyst may be charged entirely once or charged successively (continuous charging and/or intermittent charging) after starting the feeding of the monomer mixture. Particularly, when ketone such as acetone is used as the polymerization solvent, it is preferred that the polymerization catalyst is charged successively. According to the successive charging, contact of the polymerization catalyst with the enol tautomer being the tautomer of the ketone may be prohibited, leading to suppression of lowering of the catalytic activity.

In the method for the production of the present invention, to regulate the amount of the compound having active hydrogen included in the reaction system is preferred. Particularly, when the monomer mixture is allowed to be polymerized using the polymerization catalyst, it is preferred that the amount of the compound having active hydrogen included in the polymerization system upon initiation of the polymerization reaction is regulated such that the amount of the compound having active hydrogen included in the polymerization system becomes not greater than 100 mol PPM, more preferably not greater than 50 mol PPM, even more preferably not greater than 10 mol PPM, and most preferably not greater than 0 mol PPM. When the amount of the compound having active hydrogen is exceeding 100 mol PPM, molecular weight of the resulting polymer may be lowered, and still more, progress of the polymerization reaction may be deteriorated. Particularly, when acetone or methyl cyanide is used as the solvent, great influence may be exerted by the amount of the compound having active hydrogen.

Examples of the compound having active hydrogen include water, alcohol, amine, carboxylic acid, mineral acid and the like.

As in the foregoing, the method of regulating to control the amount of the compound having active hydrogen in the polymerization system is not particularly limited, but specifically, preferable examples of the method include e.g.,: physical methods of the removal by a molecular sieve treatment, an activated charcoal treatment, purification by distillation or the like; methods of carrying out a chemical reaction to remove the compound having active hydrogen using a compound that is highly reactive toward the compound having active hydrogen such as metal sodium, alkyl aluminum and the like. Among them, taking into account of industrial practical applicability, the former physical methods are more preferred. More preferable method involves the molecular sieve treatment, activated charcoal treatment, and purification by distillation.

Type of the polymerization reaction or mechanism of polymerization in the foregoing is not particularly limited, but anion polymerization, cation polymerization, coordination polymerization and immortal polymerization may be preferably exemplified. Among them, anion polymerization and coordination polymerization are more preferred because they can readily yield the product having high purity, therefore, the polymer can be obtained with favorable reproducibility, and in addition, easy handling of the polymerization catalyst is permitted thereby resulting in comparatively easy regulation of the molecular weight.

In the method for the production of the present invention, the reaction vessel used in the polymerization may be any reaction vessel which can be usually used for obtaining a polymer by a polymerization reaction, and may be preferably one that is excellent in heat resistance, chemical resistance, corrosion resistance, heat-removal property, pressure resistance and the like, but the type thereof is not particularly limited.

The reaction vessel may be one which enables the contents such as the charged solvent, fed monomer and the like therein to be agitated, which may be preferably equipped with an agitation blade thereby permitting arbitrary agitation of the contents under desired conditions. The agitation blade is not particularly limited, but specific preferable examples thereof include e.g., agitation tanks equipped with an anchor impeller, agitation tanks equipped with a helical ribbon impeller, agitation tanks equipped with a double helical ribbon impeller, agitation tanks equipped with a helical screw impeller with a draft tube, upright concentric biaxial agitations tank equipped with super blend impellers (inner impeller: MAX BLEND impeller, and outer impeller: helical modified baffle) (for example, trade name: SUPERBLEND, manufactured by Sumitomo Heavy Industries, Ltd.), agitation tanks equipped with a MAX BLEND impeller (manufactured by Sumitomo Heavy Industries, Ltd.), agitation tanks equipped with a FULLZONE impeller (manufactured by Kobelco Eco-Solutions Co., Ltd.), agitation tanks equipped with a SUPERMIX impeller (manufactured by Satake Chemical Equipment Mfg., Ltd.), agitation tanks equipped with a Hi-F mixer (manufactured by Soken Chemical & Engineering Co., Ltd.), agitation tanks equipped with a SANMELER impeller (manufactured by Mitsubishi Heavy Industries, Ltd.), agitation tanks equipped with LOGBORN (manufactured by Shinko Pantec Co., Ltd.), agitation tanks equipped with VCR (manufactured by Mitsubishi Heavy Industries, Ltd.), and agitation tanks equipped with e.g., a twisted-lattice blade (manufactured by Hitachi, Ltd.), a turbine impeller, a paddle blade, a Pfaudler blade, a BRUMARGIN blade, or a propeller blade, and the like.

The reaction vessel preferably has an outfit to enable heating in order that the contents are adjusted to not higher than a desired reaction temperature, and keeping the state. Specific examples of the outfit to enable heating and keeping include jackets, coils, outer circulation type heat exchangers and the like, but not particularly limited thereto. In addition to the aforementioned outfit in connection with agitation, heating and the like, the reaction vessel can also be arbitrarily equipped with any of various outfits on the grounds that the polymerization reaction may be efficiently carried out, such as e.g.: detector ends such as a baffle, a thermometer, a pressure gage and the like; feeding apparatuses for allowing raw materials to uniformly disperse in a liquid or a gas phase; and apparatuses for washing the inside of reaction vessels and reaction tanks.

In the method for the production of the present invention, it is preferred that the reaction vessel be used in the following manner: before the polymerization of the monomer, the reaction vessel is washed with the above solvent and then heat-dried and thereafter, the inside of reaction vessel is sufficiently replaced with an inert gas, or the inside of reaction vessel is placed in a vacuum state. Preferable examples of the inert gas include nitrogen gas, helium gas, argon gas and the like. The aforementioned solvent and inert gas preferably have high purity because: in the case in which any compound having active hydrogen such as water is contaminated, for example, there is a possibility that the inhibition of the polymerization and the lowering of the molecular weight may be caused, and when oxygen is contaminated in the case in which ethylene oxide is used as the monomer, there is a possibility that the danger of explosion of the ethylene oxide may be enlarged.

In the method for the production of the present invention, after washing as described above, a solvent is preferably charged in the reaction vessel prior to carrying out the polymerization of the monomer.

The charging amount of the solvent and the like is not particularly limited but may be regulated ad libitum taking into account of physical properties and production amount of the desired polymer.

After charging the solvent and the like, it is preferred to replace the inside of the reaction vessel again with the inert gas, or to place the inside of reaction vessel in a state of reduced pressure, and preferably in a vacuum state prior to carrying out the polymerization reaction. When the polymerization is carried out under an atmosphere as replaced with the inert gas, it is preferred that the ratio of the inert gas is not kept less than a given proportion in the gas-phase portion in the reaction vessel. In this process, the internal pressure of the reaction vessel (initial pressure) is preferably regulated by the inert gas at the same time. The internal pressure of the reaction vessel (initial pressure) is not particularly limited. When ethylene oxide, for example, is used as the monomer in light of the amount of the ethylene oxide that exists in the reaction vessel, the internal pressure may be regulated ad libitum in such an extent that the safety may be controlled.

In the method for the production of the present invention, the polymerization is preferably carried out while the monomer is agitated together with the solvent.

With regard to the agitation, it is preferred that prior to feeding the monomer into the solvent the contents such as the solvent and the like in the reaction vessel are agitated by rotating the agitation blade with which the reaction vessel is equipped, and the like. Although the timing of the beginning of the agitation is not particularly limited, the agitation may be started during the feeding, at the beginning of the feeding, or after the beginning of the polymerization. In addition, the agitation is preferably continued until the polymerization reaction is completed.

In the method for the production of the present invention, it is preferred and important that the aforementioned agitation be carried out by controlling the rotational frequency of the agitation blade and the like so that the agitation power is adjusted to not less than 0.6 kW/m³, preferably not less than 1 kW/m³, more preferably not less than 2 kW/m³. This agitation power is preferably controlled until the polymerization is completed, also involving during the feeding of the monomer.

Herein, the agitation power generally means a value that is calculated as the agitation power requirement regarded as hitherto known technical common knowledge, i.e., the necessary power per unit liquid amount of the contents in the reaction vessel, more particularly, the necessary power per unit liquid amount of the contents, which is calculated on the basis of the volume and viscosity of the contents, the shape of the reaction vessel, the shape of the agitation blade, the rotational frequency, and the like. However, in the preferred method for the production of present invention, the aforementioned agitation power may be specified to fall within the above range for the product (hereinafter, also referred to as “reaction mixture”) at the end of the polymerization reaction. Therefore, it is not always necessary that the agitation power falling within the above range should be ensured in the entire reaction system from the beginning to the end of the polymerization reaction.

In the method for the production of the present invention, although not particularly limited, in order that the agitation power falls within the above range at the end of the polymerization reaction, for example, the agitation rotational frequency that is required at the end of the polymerization reaction may be calculated on the basis of the viscosity and the capacity of the product at the end of the polymerization reaction, the shape of the agitation blades and the like, and the reaction may be allowed while the agitation rotational frequency is kept constant from the beginning to the end of the polymerization reaction. Herein, the viscosity of the product at the end of the polymerization reaction is not particularly limited, but the viscosity may be arbitrarily set in the range of, for example, 200 to 2,000,000 cps in light of the type and the using amount of the monomer, and thus, the aforementioned agitation rotational frequency can be calculated.

In the case where the above agitation power is less than 0.6 kW/m³, the flowing state in the reaction vessel may be deteriorated because the contents are not agitated uniformly, and the productivity of the polymer may be inferior. Furthermore, the local heat accumulation may also be readily caused, and the temperature distribution of the reaction liquid, and the concentration distribution of the monomer and the like may also be non-uniform, thereby leading to a possibility that an abnormal reaction (runaway reaction) is caused.

In the method for the production of the present invention, it is preferred that the reaction temperature during the polymerization reaction be regulated to control ad libitum. More preferably, the reaction temperature may be previously regulated to control before the monomer is fed into the solvent to initiate the polymerization, in a similar manner to the regulation of the internal pressure of the reaction vessel. More particularly, it is preferred that the internal temperature, which is generally referred to, is controlled so that a desired reaction temperature of the solvent and the like charged in the reaction vessel is provided beforehand. The control of this reaction temperature is preferably applied until the polymerization is completed, also including the time period during feeding of the monomer.

The aforementioned reaction temperature is not particularly limited, but is preferably not higher than 200° C., more preferably not higher than 180° C., and even more preferably not higher than 150° C. In addition, even though the aforementioned reaction temperature is constantly controlled, an error can be caused to some extent inevitably due to the influence of the type of the outfit for regulating the temperature and the variation of the temperature during feeding of the monomer. However, as long as the error is within the range of ±5° C. of the above preferable temperature range, the excellent effect can be achieved similarly to the case in which no error is present.

In the case in which the aforementioned reaction temperature is out of the above temperature range, various troubles may be caused in terms of the molecular weight of the resulting alkylene oxide based polymer. More particularly, when the above reaction temperature is higher than the aforementioned preferred range, frequency of the chain transfer reaction may be increased, thereby readily causing the lowering of the molecular weight. In a marked case, the lowering of the molecular weight may be caused to such an extent that the molecular weight cannot be controlled by merely adjusting the amount of the reaction initiator as added.

It is preferred that the control of the aforementioned reaction temperature be carried out constantly until the polymerization reaction is completed, but the reaction temperature may also be arbitrarily altered within the above temperature range depending on circumstances or when the occasion demands in the reaction operation. Exemplary alteration of this control of the temperature is not particularly limited, but a specific example thereof may be the process in which, upon polymerization of the monomer through successively feeding the same, the temperature is controlled by setting once at the stage of the beginning of the feeding, and thereafter, as the internal temperature of the reaction system is raised by the exothermic heat generated on initiation of the polymerization reaction, the temperature is subsequently controlled with the setting of this temperature after the rise. Herein, keeping the reaction temperature constant may refer to the control within the range of lower or higher than the desirable reaction temperature by 5° C.

Regulation of the aforementioned reaction temperature is not particularly limited, but the temperature of the charged contents may be regulated to control by heating the reaction vessel or the like, or by directly heating the contents. Examples of outfit to enable the adjustment of the reaction temperature include commonly used jackets, coils, and outer circulation type heat exchangers, but not particularly limited thereto.

As is described above, the method for the production of the present invention preferably includes: charging the solvent and the like in the reaction vessel, accompanied by regulating to control the aforementioned agitation power, reaction temperature and the like to fall within a specific range, and feeding the monomer into the solvent to carry out the polymerization while agitation.

Using amount of the monomer is not particularly limited, but specifically, the concentration of the alkylene oxide based polymer (polymer concentration) in the product at the end of the polymerization reaction may be, for example, greater than 10% by weight, or may be greater than 20% by weight. In connection with the using amount of the monomer, the polymer concentration of not greater than 10% by weight may result in low productivity, and inferior practical applicability.

In the method for the production of the present invention, polymerization is permitted while the monomer is agitated in the solvent. Feeding process of the monomer into the solvent is not particularly limited, but may be any one of: allowing for the polymerization by feeding the entire monomer charged in a lump; allowing for the polymerization by dividing the entire monomer and feeding each divided portion charged in a lump; or allowing for the polymerization while at least a part of the monomer is fed.

The aforementioned case of allowing for the polymerization while at least a part of the monomer is fed can be regarded as permitting the polymerization while at least a part of the monomer mixture is fed by successive charging.

Moreover, the operation of feeding at least a part of the monomer means, for example, that: a part of the total charging amount of the entire monomer mixture is fed into the solvent beforehand as an initial feeding amount (initial charging amount) and then the polymerization may be allowed while the residual portion is fed; or the polymerization may be allowed while the entire amount of the monomer mixture is fed.

The above successive addition means feeding continuously and/or intermittently (hereinafter, may be referred to as “continuous feeding” and “intermittent feeding”, respectively). The “continuous feeding” means to continuously feed little by little, and the “intermittent feeding” means to intermittently feed by dividing the charging amount for arbitrary times, for example, to feed in a few divided portions. The continuous feeding is more preferred because it can be carried out at a desired reaction temperature, which can be readily controlled constant. With regard to this control of the reaction temperature, the feeding rate is preferably regulated in accordance with type of the raw materials of the copolymer and the like. More particularly, the feeding rate is preferably regulated in light of the reaction rate of the monomer employed, and the heat-removing ability or permissible pressure of the reaction vessel employed. In addition, the continuous and/or intermittent feeding also includes a feeding process that is a combination of the continuous feeding and the intermittent feeding, such as e.g., intermittent feeding as a whole, but involving continuous feeding in each of the intermittent feeding.

In the method for the production of the present invention, when the polymerization is allowed while at least a part of the monomer is fed into the solvent, the reaction may be allowed to proceed until completion of the feeding while the feeding rate is kept constant, as described above. However, for example, when a monomer mixture including multiple kinds of monomers admixed is polymerized, the melting point of the polymer can be regulated within the acceptable range by altering the feeding rate of at least one of the essential raw materials (for example, ethylene oxide, the substituted oxirane compound and the like) in the monomer mixture. The alteration of the feeding rate is not particularly limited but may be the alteration to result in the change into an arbitrary different rate at least one time. In this case, the alteration of the rate may be: carried out in a moment (continuously); not in a moment but continuously while the rate itself is altered until the rate after the alteration is reached; or with an intervened period in which the feeding is not carried out temporarily. Similarly, the alteration of the feeding rate may also be the alteration to result in the continuously altered rate itself arbitrarily. In this case, the alteration rate of the rate itself may be either constant or not, which is not particularly limited. In addition, the alteration of the feeding rate may be any combination of these modes of the alteration. The alteration of the feeding rate should be considered for each of the various monomers to be the aforementioned essential raw material from the beginning to the end of the feeding. In the present invention, when ethylene oxide is used as the monomer, absorption of the ethylene oxide in a liquid phase may become difficult in a state in which high viscosity is yielded in the later stage of the reaction. Accordingly, it is advantageous to make the feeding rate slow in the later stage of the reaction.

Furthermore, in the method for the production of the present invention, in the case where the monomer mixture including multiple kinds of monomers admixed is allowed to be polymerized, and where at least a part of this monomer mixture is allowed to be polymerized while being fed into the solvent, the melting point of the polymer can be regulated within the acceptable range by allowing a period to be present during which at least one of the essential raw materials in the monomer mixture (for example, ethylene oxide and the substituted oxirane compound) is not fed. There should exist the aforementioned period from the beginning of the feeding of at least one monomer included in the monomer mixture to the end of the feeding of all the monomers included in the monomer mixture.

Additionally, when ethylene oxide and other monomer (monomer other than ethylene oxide) are used as the monomer, feeding of the monomers can be performed to involve at least each one of: a step of feeding the ethylene oxide alone to permit the polymerization, and step of feeding ethylene oxide and other monomer to permit the polymerization.

In the method for the production of the present invention, after completion of the feeding of the monomer, the resultant product in the reaction vessel is preferably aged as needed. Conditions (e.g., temperature, time and the like) employed in the aging are not particularly limited, which may be predetermined ad libitum.

Because there may be a case where the solvent and unreacted raw monomer material exist in a gas phase when the pressure in the reaction vessel is released after the feeding or the aging as described above, they are preferably subjected to complete combustion as needed, using a combustion apparatus for discharged gases (for example, combustion furnace or combustion catalyst). In addition, steam (vapor) can be obtained by recovering the heat generated in this process.

In the method for the production of the present invention, a solvent may be further added, as needed, to the alkylene oxide based polymer obtained following the above feeding or aging, and the aforementioned polymer may be dissolved so as to have a desired viscosity and concentration. The solvent which may be used in this step is not particularly limited, but the solvent which was used in the polymerization is preferred. In addition, various stabilizers such as antioxidants, solubilizing agents and the like may be also added as needed together with this solvent. The various stabilizers, solubilizing agents and the like may be added any time without particular limitation, which may be added either after blending with the aforementioned solvent or separately.

The method for the production of the present invention may include any other step which is not particularly limited, in addition to the various steps as described above such as polymerization step of carrying out the polymerization of the monomer through feeding the monomer into the solvent and agitating the mixture; and the aging step of carrying out the aging of the product obtained in the polymerization step. For example, the method may further include a step of volatilizing a part of the solvent component from the resulting product to adjust the concentration of the alkylene oxide based polymer solution (devolatilization step, generally referred to), subsequently to the aforementioned polymerization step, and the aging step which may be carried out as needed.

With respect to devolatilization method, and apparatus and various conditions employed in the devolatilization, any method which can be employed in common devolatilization, and any usable apparatus and conditions which may be set can be adopted. Their details will be illustrated below.

Apparatus used in the devolatilization (devolatilization apparatus) is not particularly limited, although there may be the case in which the tank used for the polymerization is directly used in this step. Examples of preferable apparatus include agitation tanks equipped with a helical impeller, agitation tanks equipped with a double helical ribbon impeller, upright concentric biaxial agitation tanks (for example, trade name: SUPERBLEND, manufactured by Sumitomo Heavy Industries, Ltd.) equipped with a super blend impeller (inner impeller: MAX BLEND impeller, and outer impeller: helical modified baffle), agitation tank evaporators such as reactors of VCR inverted cone ribbon blade type (manufactured by Mitsubishi Heavy Industries, Ltd.); falling-film evaporators such as shell-and-tube-heat-exchanger-type evaporators (e.g., trade name: Sulzer Mixer, manufactured by Sumitomo Heavy Industries. Ltd.; and trade name: Static Mixer, manufactured by Noritake Co., Ltd.), and plate-heat-exchanger-type evaporators (e.g., trade name: Hiviscous Evaporator, manufactured by Mitsui Engineering & Shipbuilding Co., Ltd.); thin-film evaporators such as horizontal thin-film evaporators (e.g., trade name: EVA reactor, manufactured by Kansai Chemical Engineering Co., Ltd.), fixed-blade-type vertical thin-film evaporators (e.g., trade name: EXEVA, manufactured by Kobelco Eco-Solutions Co., Ltd.), movable-blade-type vertical thin-film evaporators (e.g., trade name: WIPRENE, manufactured by Kobelco Eco-Solutions Co., Ltd.), and tank-type (mirror-type) thin-film evaporators (e.g., trade name: Recovery, manufactured by Kansai Chemical Engineering Co., Ltd.); surface-renewal-type polymerization vessels such as single-screw surface-renewal-type polymerization vessels, and twin-screw surface-renewal-type polymerization vessels (e.g., trade name: BIVOLAK, manufactured by Sumitomo Heavy Industries. Ltd.; trade name: Hitachi spectacle-shaped blade polymerization machine, manufactured by Hitachi, Ltd.; Hitachi lattice-blade polymerization machine, manufactured by Hitachi, Ltd.; and trade name: SC processor, manufactured by Kurimoto, Ltd.); kneaders; roll mixers; intensive mixers (banbury mixer, generally referred to); extruders such as single-screw extruders, twin-screw extruders (e.g., trade name: SUPERTEX αII, manufactured by Japan Steel Works, Ltd.; trade name: BT-30-S2, manufactured by PLABOR Co., Ltd.), and a SCR self-cleaning-type reactor (manufactured by Mitsubishi Heavy Industries, Ltd.); and the like. At least one of these apparatuses is preferably used to carry out devolatilization. Additionally, conditions for use of the apparatus may be set ad libitum depending on the apparatus employed.

At an adequate time after terminating the polymerization (i.e., timing at which the solvent is removed, or an appropriate time during, before or after the addition of the solvent, or the like), a substance for terminating the polymerization such as e.g., a compound having active hydrogen, as well as a substance for deactivating the catalyst such as e.g., required minimum oxygen can be added.

In order to obtain an ethylene oxide based polymer (preferably, ethylene oxide based copolymer) having physical properties that enable formation of a film or sheet having flexibility and less tack in the method for the production of the present invention, the melting point of the alkylene oxide based polymer is preferably not higher than 60° C., more preferably not higher than 55° C., and particularly preferably not higher than 51° C. When the melting point is higher than 60° C., a film or sheet having flexibility can not be obtained, as the case may be.

Additionally, the ethylene oxide based polymer (preferably, ethylene oxide based copolymer) has a weight average molecular weight (Mw) of preferably not lower than 10,000, more preferably not lower than 30,000, and particularly preferably not lower than 60,000. When the weight average molecular weight (Mw) is lower than 10,000, the tack may be developed on the film or sheet. Furthermore, low viscosity is preferred upon carrying out casting or coating, therefore, the alkylene oxide based copolymer has a weight average molecular weight (Mw) of preferably not higher than 500,000, more preferably not higher than 300,000, and particularly preferably not higher than 150,000.

The alkylene oxide based polymer obtained according to the present invention is not particularly limited, but it can be preferably used in very broad range of applications. Specific examples of the application include e.g., polyurethane resins such as glues, adhesives, paints, sealing agents, elastomers, flooring materials and the like, as well as various functional materials such as hard, soft or semi-hard polyurethane resins, and surfactants, sanitary products, deinking agents, lubricating oils, hydraulic oils, polyelectrolytes, battery materials, flexographic printing plate materials, protective films for color filters, and the like.

### EXAMPLES

The present invention will be explained more specifically below by way of Examples, however, the present invention is not any how limited thereto.

Various conditions of measurement, setting, and treatment in the following Examples and Comparative Examples will be shown below. In the following description, “L” denotes the unit of “liter”.

[Setting of Agitation Power (Pv)]

The rotational frequency of agitation blades required for a desirable agitation power was calculated on the basis of the viscosity of a reaction mixture at the end of the polymerization reaction, the capacity of the contents of the reaction mixture in the polymerization vessel at the end of the polymerization reaction and the shape of the reaction vessel including a blade shape. Thus, experiments were conducted with the rotational frequency.

[Dehydration Treatment Using Molecular-Sieve]

After adding 10% by weight of molecular sieve to the solvent and the raw monomer material to be dried, replacement with nitrogen was carried out.

The used molecular sieve had a product name of Molecular Sieve (type: 4A 1.6), which was manufactured by Union Showa Co., Ltd.

[Measurement of Moisture Content in Solvent]

The moisture content was measured by using a Karl-Fischer apparatus for measuring moisture content (coulometric titration method, AQ-7, manufactured by Hiranuma Sangyo).

[Measurement of Weight Average Molecular Weight (Mw) and Number Average Molecular Weight (Mn)]

Measurement was performed with a GPC apparatus, with the calibration curve produced using a standard molecular weight sample of polyethylene oxide. The measurement was carried out after the reaction mixture obtained following the reaction (including the polymer) was dissolved in a predetermined solvent.

[Measurement of Viscosity Average Molecular Weight (Mv)]

Limiting viscosity of each solution including polyethylene oxide having a viscosity average molecular weight of 50,000, 100,000 and 300,000 dissolved in water was measured, respectively, using an Ubbelohde type viscometer. Based on the results of this measurement, a calibration curve was produced. Using an Ubbelohde type viscometer, limiting viscosity of the aqueous solution of the polymer sample obtained by the polymerization reaction was measured. The viscosity average molecular weight (Mv) was calculated from the results of this measurement, and the calibration curve as described above.

[Flexibility and Tack]

Flexibility was determined by bending with hand the sheet obtained by casting, and the tack was determined by touching with fingers. Evaluation was made for favorable one as A, somewhat inferior one as B, and inferior one as C.

[Examples of Preparation of Polymerization Catalyst, and Polymerization Catalyst]

[Polymerization Catalyst A1]

In a flask substituted with nitrogen were charged 18 g of n-hexane, 48 g of Solvent No. 0 manufactured by Nihon Sekiyu, Co. Ltd., and 7.4 g of diethyl zinc. To the mixture was added dropwise 4.3 g of 1,4-butanediol in small portions under cooling and stirring vigorously. After completing the dropwise addition, the reaction was terminated by stirring at 30° C. for 1 hour, and at 50° C. for 1 hour. As the second step, the reaction was allowed by gradually adding 3.6 g of ethyl alcohol dropwise to the reaction liquid at an internal temperature of 20° C. Thereafter, the reaction was completed by stirring at 40° C. for 1 hour. Additionally, the reaction liquid was subjected to a heat treatment at 140° C. for 20 min, and the unreacted components were concomitantly removed by distillation. As a result, a white-turbid and somewhat viscous liquid polymerization catalyst A1 was obtained.

[Polymerization Catalyst B1]

An autoclave equipped with a stirrer was dried and replaced with nitrogen, and therein were charged 158.7 g of triisobutyl aluminum, 1170 g of toluene and 296.4 g of diethyl ether. The internal temperature was set to 30° C., and 23.5 g of phosphoric acid was added over 10 min at a constant rate while stirring. Thereto was added 12.1 g of triethylamine, and an aging reaction was allowed at 60° C. for 2 hours to give a catalyst solution of a polymerization catalyst B1.

[Polymerization Catalyst C1]

Polymerization catalyst C1 is a 12.6% by weight solution of t-butoxy potassium (potassium t-butoxide) in tetrahydrofuran (THF).

[Polymerization Catalyst D1]

Polymerization catalyst D1 is Sn oxalate (Aldrich reagent). The Aldrich reagent means a reagent manufactured by SIGMA-ALDRICH Co.

[Polymerization Catalyst E1]

Polymerization catalyst E1 is tetrabutylammonium hydroxide·30H₂O (Aldrich reagent).

[Polymerization Catalyst F1]

Polymerization catalyst F1 is SnCl₄ (Aldrich reagent)

[Polymerization Catalyst G1]

Polymerization catalyst G1 is a solution of t-butoxy potassium (potassium t-butoxide) in THF (Aldrich reagent; 1.0 mol/l).

[Polymerization Catalyst H1]

Polymerization catalyst H1 is aluminum tri-i-propoxide (Al(O-i-Pr)₃; reagent manufactured by Wako Pure Chemical Industries, Ltd.).

[Polymerization Catalyst I1]

Polymerization catalyst I1 is gallium tri-i-propoxide (Ga(O-i-Pr)₃; reagent manufactured by Wako Pure Chemical Industries, Ltd.).

[Polymerization Catalyst J1]

Polymerization catalyst J1 is cerium tri-i-propoxide (Ce(O-i-Pr)₃); reagent manufactured by Kojundo Chemical Lab. Co., Ltd.).

[Polymerization Catalyst K1]

Polymerization catalyst K1 is diethoxyzinc (Zn(OEt)₂; reagent manufactured by Kojundo Chemical Lab. Co., Ltd.).

[Polymerization Catalyst L1]

Polymerization catalyst L1 is zirconium tetra-t-butoxide (Zn(O-t-Bu)₄; reagent manufactured by Kojundo Chemical Lab. Co., Ltd.).

[Polymerization Catalyst M1]

Polymerization catalyst M1 is aluminum tri-t-butoxide (Al(O-t-Bu)₃; reagent manufactured by Kojundo Chemical Lab. Co., Ltd.).

[Polymerization Catalyst N1]

Polymerization catalyst N1 is sodium t-butoxide (NaO-t-Bu; reagent manufactured by Kojundo Chemical Lab. Co., Ltd.).

[Polymerization Catalyst O1]

Polymerization catalyst O1 is potassium i-propoxide (KO-i-Pr; reagent manufactured by Kojundo Chemical Lab. Co., Ltd.).

[Polymerization Catalyst P1]

Polymerization catalyst P1 is potassium ethoxide (KOEt; reagent manufactured by Kojundo Chemical Lab. Co., Ltd.).

[Polymerization Catalyst Q1]

Polymerization catalyst Q1 is zinc chloride (ZnCl₂; reagent manufactured by Wako Pure Chemical Industries, Ltd.)

[Polymerization Catalyst R1]

Polymerization catalyst R1 is gallium trichloride (GaCl₃; reagent manufactured by Wako Pure Chemical Industries, Ltd.).

[Polymerization Catalyst S1]

Polymerization catalyst S1 is titanium tetrachloride (TiCl₄; reagent manufactured by Wako Pure Chemical Industries, Ltd.).

[Polymerization Catalyst T1]

Polymerization catalyst T1 is aluminum trichloride (AlCl₃; reagent manufactured by Wako Pure Chemical Industries, Ltd.).

[Polymerization Catalyst U1]

Polymerization catalyst U1 is calcium di-i-propoxide (Ca(O-i-Pr)₂; reagent manufactured by Kojundo Chemical Lab. Co., Ltd.).

[Polymerization Catalyst V1]

Polymerization catalyst V1 is magnesium di-ethoxide (Mg(OEt)₂; reagent manufactured by Wako Pure Chemical Industries, Ltd.).

[Polymerization Catalyst W1]

Polymerization catalyst W1 is lithium methoxide (LiOMe; reagent manufactured by Kojundo Chemical Lab. Co., Ltd.).

[Polymerization Catalyst X1]

Polymerization catalyst X1 is magnesium chloride (MgCl₂; reagent manufactured by Wako Pure Chemical Industries, Ltd.)

[Polymerization Catalyst Y1]

In a 100-ml three-neck flask equipped with a Liebig condenser were charged 6.09 g of tributyltin chloride (manufactured by Wako Pure Chemical Industries, Ltd.) and 21.30 g of butyl phosphate (manufactured by Wako Pure Chemical Industries, Ltd.). Inside of the flask was replaced with nitrogen, and was sufficiently dried. Furthermore, the 100-ml three-neck flask was heated with a silicon oil bath while nitrogen was circulated in the flask and condenser. The oil bath was heated to about 260° C. Along with rise of the temperature of the oil bath, the temperature inside of the flask was also elevated. When the temperature became 156° C., outflow of the condensate started. Continuation of the heating resulted in the temperature in the flask of 235° C. Additionally, the heating was continued to allow for outflow of the condensate. When heating was continued also after the amount of the condensate decreased, transparent liquid in the flask was turned into the solid. Hardening and the absence of the distillate were ascertained to decide the termination. Thus resulting solid was scraped with a spatula, and ground in a mortar to obtain a polymerization catalyst Y1.

[Polymerization Catalyst Z1]

The operation of charging described below in connection with the polymerization catalyst Z1 described below was carried out in a glove box with nitrogen entirely circulating therein. In a 500-ml eggplant-shaped flask were charged 32 g of dehydrated hexane (manufactured by Wako Pure Chemical Industries, Ltd.) and 50 ml of 1.0 mol/l triethylaluminum (manufactured by Wako Pure Chemical Industries, Ltd.). The 500-ml eggplant-shaped flask was ice-cooled while stirring the contents with a stirrer. A preparatory liquid of 0.45 g of distilled water dissolved in 12.0 g of THF (manufactured by Wako Pure Chemical Industries, Ltd.) was slowly added dropwise using a syringe. Generation of gas and heat was confirmed. Subsequently, a preparatory liquid of 2.50 g of acetyl acetone (manufactured by Wako Pure Chemical Industries, Ltd.) dissolved in 15.01 g of dehydrated hexane (manufactured by Wako Pure Chemical Industries, Ltd.) was slowly added dropwise using a syringe. Generation of gas and heat was confirmed. Ice-cooling was stopped, and the mixture was kept stirring at a room temperature. Thus resulting hexane solution was designated as polymerization catalyst Z1.

[Polymerization Catalyst A2]

The operation of charging described below in connection with the polymerization catalyst A2 described below was carried out in a glove box with nitrogen entirely circulating therein. In a 500-ml eggplant-shaped flask were charged 32 g of dehydrated hexane (manufactured by Wako Pure Chemical Industries, Ltd.) and 50 ml of 1.0 mol/l triethylaluminum (manufactured by Wako Pure Chemical Industries, Ltd.). The 500-ml eggplant-shaped flask was ice-cooled while stirring the contents with a stirrer. A preparatory liquid of 0.45 g of distilled water dissolved in 12.12 g of THF (manufactured by Wako Pure Chemical Industries, Ltd.) was slowly added dropwise using a syringe. Generation of gas and heat was confirmed. Ice-cooling was stopped, and the mixture was kept stirring at a room temperature. Thus resulting hexane solution was designated as polymerization catalyst A2.

[Polymerization Catalyst B2]

Polymerization catalyst B2 was PMAO-S (a solution of polymethyl aluminoxane in toluene: manufactured by Tosoh Finechem Corporation; Al concentration 7.6% by weight).

[Polymerization Catalyst C2]

Polymerization catalyst C2 was a solution of diethylzinc in toluene (concentration 20.5% by weight).

[Polymerization Catalyst D2]

The operation of charging described below in connection with the polymerization catalyst D2 described below was carried out in a glove box with nitrogen entirely circulating therein. In a 100-ml three-neck flask were charged 0.36 g of distilled water (19.98 mmol), 49.76 g of dehydrated toluene (manufactured by Wako Pure Chemical Industries, Ltd.), and 12.12 g of a 20.5% by weight solution of diethylzinc in toluene (20.12 mmol). The mixture in the 100-ml three-neck flask was stirred at room temperature for 30 min with a stirrer. Generation of heat and gas was confirmed. Yellow slurry was yielded. Furthermore, the flask was heated with an oil bath to give the internal temperature of 60° C. Heating at 60° C. was kept for 3 hours. Confirmation of generation of the gas ceased, and then, termination of the reaction was identified. Finally obtained product was designated as polymerization catalyst D2.

[Polymerization Catalyst E2]

The operation of charging in connection with the polymerization catalyst E2 described below was carried out in a glove box with nitrogen entirely circulating therein. In a 500-ml separable flask were charged 15 ml of dehydrated hexane (manufactured by Wako Pure Chemical Industries, Ltd.) and 30 ml of a 1.0 mol/l diethylzinc solution in hexane (manufactured by Wako Pure Chemical Industries, Ltd.). Stirring of the mixture in the flask was started at room temperature. A solution of 1.72 g of 1,4-butanediol (manufactured by Wako Pure Chemical Industries, Ltd.) dissolved in 15.65 g of tetrahydrofuran (manufactured by Wako Pure Chemical Industries, Ltd.) was added dropwise using a syringe to the 500-ml separable flask over about 20 min. Stirring was kept at room temperature for 1 hour. Additionally, the mixture was heated while stirring at 50° C. for 1 hour. After allowing the mixture to reach to room temperature, thereto was added a solution of 0.70 g of dehydrated methanol (manufactured by Wako Pure Chemical Industries, Ltd.) dissolved in 12.88 g of dehydrated hexane (manufactured by Wako Pure Chemical Industries, Ltd.) dropwise using a syringe in about 5 min. Furthermore, the mixture was stirred at 40° C. for 1 hour. Polymerization catalyst E2 was obtained as a white slurry.

### Example a1

A reaction vessel of 1 L equipped with a MAX BLEND impeller (manufactured by Sumitomo Heavy Industries. Ltd.), a jacket, and an addition inlet was washed with a solvent, and thereafter it was heat-dried and replaced with nitrogen. To this reaction vessel, 345 g of ethyl acetate which had been subjected to a dehydrating treatment, and 0.5 g of the polymerization catalyst A1 were charged sequentially. After the charging, the atmosphere in the reaction vessel was replaced with nitrogen, and was pressurized with nitrogen until the pressure in the reaction vessel reached 0.4 MPa. After confirming that the internal temperature reached 30° C., 82 g of ethylene oxide and 8 g of butylene oxide that had been subjected to a dehydrating treatment were quantitatively fed over 6 hours at a constant feeding rate. After completing the feeding, aging was carried out by further keeping at not lower than 30° C. for 5 hours.

According to the foregoing operation, a reaction mixture including a polymer having a weight average molecular weight Mw of 450,000 was obtained. The melting point gave two peaks at 36° C. and 46° C.

### Example a2 to Example a7

Similar operation to Example a1 was carried out except that type of the polymerization solvent, type and amount of the polymerization catalyst, type and amount of the monomer, moisture content in the polymerization system, agitation power, method of feeding the monomer were changed, and polymerization and evaluation were carried out. The results are shown in Table 1. The amount of the solvent was 345 g in all of the Example a1 to Example a7.

TABLE 1
Specifications and Evaluation Results of Examples a1 to a7

| | Polymerization Conditions | | | | | | | Physical Properties of | | | | |
|---|---|---|---|---|---|---|---|---|---|---|---|---|
| | | Polymerization | | | | | | Ethylene Oxide based Copolymer | | | | |
| | | Catalyst | | | | | | Molecular | Melting point | | | |
| | | | Amount | Moisture | Agitation Power | Temperature | Other | weight | First | Second | | Flexi- |
| Example | Solvent type | Type | (g) | (mole PPM) | (KW/m³) | (° C.) | Condition | Mw | (° C.) | (° C.) | Tack | bility |
| a1 | Ethyl acetate | A1 | 0.5 | 30 | 5 | 30 | — | 450000 | 36 | 46 | A | A |
| a2 | Methyl cyanide | A1 | 0.5 | 30 | 5 | 30 | — | 80000 | 36 | 46 | A | A |
| a3 | Tetrahydrofuran | B1 | 12.0 | 50 | 1 | 30→60 | Note-1 | 300000 | 34 | 43 | A | A |
| a4 | Tetrahydrofuran | C1 | 0.7 | 60 | 0.8 | 100 | Note-2 | 110000 | 39 | 49 | A | A |
| a5 | Trichloromethane | D1 | 3.0 | 20 | 0.8 | 60 | — | 70000 | 36 | 46 | A | A |
| a6 | Methyl ethyl | E1 | 10.0 | 30 | 1 | 70 | — | 50000 | 34 | 44 | A | A |
| | ketone | | | | | | | | | | | |
| a7 | Acetone | F1 | 6.0 | 60 | 3 | 50 | — | 20000 | 33 | 43 | B | B |

### Comparative Examples a1 and a2

### Comparative Example a1

### Preparation Example of Catalyst; Polymerization Catalyst F2

In a 500-ml flask well dried and sufficiently replaced with nitrogen were charged 17 ml of dehydrated hexane, 25 ml of a 20.7% by weight diethylzinc solution (about 18.62 g) in hexane, and thereto was added 1.79 g of 1,4-butanediol (a mixed solution in 9.0 g of dehydrated tetrahydrofuran and 15 ml of dehydrated hexane) dropwise using a syringe at room temperature over about 1 hour. A milky dispersion was formed while generating a gas. After completing the dropwise addition, the dispersion was stirred at room temperature for about 1 hour. Thereafter, stirring at 50° C. was conducted for about 1 hour. The mixture was cooled to room temperature, and thereto was added a mixed solution of 0.99 g of methanol and 12.5 g of hexane dropwise with a syringe in about 40 min. Thereafter, the mixture was heated to about 40° C., and stirred for 1 hour. Catalyst F2 was obtained as a hexane slurry including white powder.

### Polymerization Example According to Comparative Example a1

Next, in a 1 L autoclave was charged 250 ml of dehydrated hexane, and thereto was placed a 1/10 aliquot of total amount of the slurry of the catalyst F2 obtained by the above operation. Thereto was charged 50.5 g of ethylene oxide, and the polymerization was carried out at 20° C. The polymerization was completed in about 230 min after the generation of heat was started. Thus, a dispersion of polyethylene oxide in hexane was obtained with an inversion rate of about 98%. The molecular weight was about 4,500,000. No solution was obtained.

### Comparative Example a2

### Preparation Example of Catalyst; Polymerization Catalyst G2

In a 100-ml three-neck flask well dried and sufficiently replaced with nitrogen were charged 6.0 g of tributyltin chloride and 21.0 g of tributyl phosphate. Subsequently, the mixture was heated to 250° C. to distillate off the liquid. The distillation was almost completed in about 1.5 hours after the internal temperature was elevated to not lower than 230° C., with 33.97 g of the catalyst powder being left on the bottom of the flask. This catalyst powder was designated as catalyst G2.

### Polymerization Example according to Comparative Example a2

Next, in a 1 L autoclave was charged 500 g of dehydrated hexane, to which 0.50 g of the catalyst powder (catalyst G2) was placed, and the temperature was kept at 20° C. Ethylene oxide in an amount of 100.0 g was charged continuously with a feeding pump over 3 hours. Accordingly, a dispersion of polyethylene oxide in hexane was obtained with an inversion rate of about 95%. No solution was obtained.

With respect to “Note-1” shown in Table 1, composition and amount of the monomer, and the method of feeding were changed in Example a3 from those in Example a1 as described below.

Note-1: After the internal temperature reaches to 30° C., 0.6 g of ethylene oxide was added to permit the reaction. Next, 0.6 g of ethylene oxide which had been subjected to a dehydrating treatment by molecular sieve, and 0.6 g of propylene oxide were allowed to react, resulting in formation of a seed. Next, the internal temperature was set to 60° C., and thereafter, in this polymerization reaction liquid including thus formed seed, were fed 47.8 g of ethylene oxide, propylene oxide which had been subjected to a dehydrating treatment by molecular sieve and allylglycidyl ether, in an amount of 5.4 g and 1.2 g, respectively over 6 hours at the same feeding rate.

Moreover, with respect to “Note-2” shown in Table 1, composition and amount of the monomer, and the method of feeding were changed in Example a4 from those in Example a1 as described below.

Note-2: After the internal temperature reaches to 100° C., 8.4 g of ethylene oxide alone was fed over 30 min. Next, 50.4 g of ethylene oxide and 6 g of butylene oxide which had been subjected to a dehydrating treatment by molecular sieve, and 2 g of allylglycidyl ether which had been subjected to a dehydrating treatment by molecular sieve were fed over 3 hours. Next, ethylene oxide alone in an amount of 25.2 g was fed over 1 hour and 30 min. After completing the feeding, aging was carried out through keeping at not lower than 90° C. for 5 hours.

### Example b1

Into a glove box in a dry state consistently by circulation of nitrogen was placed a 100-ml autoclave (manufactured by Taiatsu Techno Corporation). The 100-ml autoclave was dried by circulating dry nitrogen over night or longer. The autoclave has a vessel part for charging the reaction liquid, and a lid part equipped with the agitator and valve, with both parts fastened by hand for use in drying. After the drying, the lid part and the vessel part were detached to carry out the charging operation. After the charging, the autoclave was loosely fastened by hand, which was thereafter removed from the glove box, and additionally fastened by a crescent wrench.

First, into the vessel part of the autoclave was charged 30 g of dehydrated acetone (manufactured by Wako Pure Chemical Industries, Ltd.; moisture content 11.6 ppm) as a solvent. Then, 0.82 g of the aforementioned polymerization catalyst G1, i.e., a solution of potassium t-butoxide (0.9 mmol) in THF (reagent manufactured by Aldrich; 1.0 mol/l) was charged as a catalyst. Next, the inside of the autoclave was replaced with nitrogen three times with a nitrogen cylinder at 0.5 MPa, and thereafter was further compressed again at 0.5 MPa. Subsequently, the vessel part of the autoclave was dipped into a 110° C. oil bath to execute heating. At this time, agitation was started.

The temperature inside of the autoclave of not lower than 95° C. was confirmed, and 5 g of ethylene oxide was fed with a metering pump. When rise in temperature and rise in pressure in the autoclave subsided, 5 g of ethylene oxide was further fed with the metering pump. Thereafter, the temperature of the oil bath was regulated and kept so that the temperature in the autoclave was kept at 100° C. for 5 hours. After the aging reaction for 5 hours, the vessel part of the autoclave was cooled by dipping in a bucket filled with water. Following the confirmation of termination of the cooling to approximately the room temperature, the valve was unfastened to release the internal pressure there by turning back to the ordinary pressure.

Next, the lid part and the vessel part of the autoclave were separated by opening with a crescent wrench. The polymer solution was recovered by repacking into a glass bottle. Inversion rate of the monomer (ethylene oxide) was 99% as determined from the change in the weight of the residue left after volatilizing the solvent (residual ratio). As a consequence of measuring the molecular weight by GPC, the number average molecular weight (Mn) was 350, and the weight average molecular weight (Mw) was 430. The results are shown in the following Table 2.

### Examples b2 to b15

In a similar manner to Example b1 except that the amount of the polymerization catalyst and the catalyst was changed as shown in Table 2, Examples b2 to b15 were performed. Specifications of the catalyst and the like, conditions and results are summarized in Table 2 below.

In the following Table 2 to Table 7, “Catalyst Amount (g)” is represented by the weight including the solvent and the like for dissolving the catalyst, while “Catalyst Amount (mmol)” is represented by the number of moles (unit being mmol) of the catalyst alone without including the solvent and the like.

### Example b16

In a similar manner to Example b1 except that the reaction temperature (polymerization temperature) was changed as shown in Table 2, Examples b16 was performed. Specifications of the catalyst and the like, conditions and results are summarized in Table 2 below.

### Example b17

In a similar manner to Example b1 except that the reaction temperature (polymerization temperature) and the reaction time (polymerization time) were changed as shown in Table 2, Examples b17 was performed. Specifications of the catalyst and the like, conditions and results are summarized in Table 2 below.

TABLE 2
Specifications and Evaluation Results of Examples b1 to b17

| | | Catalyst | Catalyst | | | | | |
|---|---|---|---|---|---|---|---|---|
| | | Amount | Amount | Polymerization | Polymerization | Inversion | | |
| Example | Catalyst | (g) | (mmol) | Temperature | Time | Rate | Mn | Mw |
| b1 | KO-t-Bu | 0.82 g | 0.9 | 100° C. | 5 hrs | 99% | 350 | 430 |
| b2 | Al(O-i-Pr)₃ | 0.17 g | 0.9 | 100° C. | 5 hrs | 4% | 200 | 3600 |
| b3 | Ga(O-i-Pr)₃ | 0.24 g | 0.9 | 100° C. | 5 hrs | 13% | 210 | 350 |
| b4 | Ce(O-i-Pr)₃ | 0.28 g | 0.9 | 100° C. | 5 hrs | 0.50% | 940 | 1100 |
| b5 | Zn(OEt)₂ | 0.13 g | 0.9 | 100° C. | 5 hrs | 5% | 180 | 270 |
| b6 | Zr(O-t-Bu)₄ | 1.33 g | 3.5 | 100° C. | 5 hrs | 4% | 130 | 140 |
| b7 | Al(O-t-Bu)₃ | 0.21 g | 0.9 | 100° C. | 5 hrs | 4% | 280 | 520 |
| b8 | Al(O-i-Pr)₃ | 0.17 g | 0.9 | 100° C. | 5 hrs | 4% | 200 | 3600 |
| b9 | NaO-t-Bu | 0.09 g | 0.9 | 100° C. | 5 hrs | 33% | 230 | 290 |
| b10 | KO-i-PrO | 0.09 g | 0.9 | 100° C. | 5 hrs | 65% | 210 | 330 |
| b11 | KOEt | 0.08 g | 0.9 | 100° C. | 5 hrs | 96% | 60 | 260 |
| b12 | ZnCl₂ | 0.13 g | 0.9 | 100° C. | 5 hrs | 2% | 30 | 40 |
| b13 | GaCl₃ | 0.18 g | 0.9 | 100° C. | 5 hrs | 25% | 150 | 200 |
| b14 | TiCl₄ | 0.18 g | 0.9 | 100° C. | 5 hrs | 5% | 190 | 400 |
| b15 | AlCl₃ | 0.12 g | 0.9 | 100° C. | 5 hrs | 1% | 140 | 1300 |
| b16 | KO-t-Bu | 0.82 g | 0.9 | 80° C. | 5 hrs | 39% | 230 | 370 |
| b17 | KO-t-Bu | 0.82 g | 0.9 | 60° C. | 24 hrs | 79% | 110 | 400 |

### Comparative Examples b1 to b4

In a similar manner to Example b1 except that the polymerization catalyst was changed as shown in Table 3, Comparative Example b1, Comparative Example b2, Comparative Example b3 and Comparative Example b4 were performed. However, in all of the Comparative Example b1, Comparative Example b2, Comparative Example b3 and Comparative Example b4, heat of the reaction was not ascertained, and also, the polymer component was not obtained. Specifications of the catalyst and the like, conditions and results are summarized in Table 3 below.

TABLE 3
Specifications and Evaluation Results of Comparative Examples b1 to b4

| Comparative | | Catalyst | Catalyst | Polymerization | Polymerization | Inversion |
|---|---|---|---|---|---|---|
| Example | Catalyst | Amount | Amount (mmol) | Temperature | Time | Rate |
| b1 | Ca(O-i-Pr)₂ | 0.15 g | 0.9 | 100° C. | 5 hrs | 0% |
| b2 | Mg(OEt)₂ | 0.11 g | 0.9 | 100° C. | 5 hrs | 0% |
| b3 | LiOMe | 0.03 g | 0.9 | 100° C. | 5 hrs | 0% |
| b4 | MgCl₂ | 0.09 g | 0.9 | 100° C. | 5 hrs | 0% |

### Example b18

In a similar manner to Example b1 except that the polymerization catalyst Y1 was used as the polymerization catalyst, and that the amount of the catalyst was as shown in Table 4 below, Examples b18 was performed. Specifications of the catalyst and the like, conditions and results are summarized in Table 4 below.

### Examples b19 and b20

In a similar manner to Example b1 except that the polymerization catalyst Z1 was used as the polymerization catalyst, and that the amount of the catalyst was as shown in Table 4 below, Examples b19 and Example b20 were performed. Specifications of the catalyst and the like, conditions and results are summarized in Table 4 below. The amount of the catalyst (adding amount of the catalyst) was calculated based on the Al atom (weight). Because the molecular weight could not be measured with GPC, it was determined in terms of the viscosity average molecular weight (Mv).

### Examples b21 and b22

In a similar manner to Example b1 except that the polymerization catalyst A2 was used as the polymerization catalyst, and that the amount of the catalyst was as shown in Table 4 below, Examples b21 and Example b22 were performed. Specifications of the catalyst and the like, conditions and results are summarized in Table 4 below. The amount of the catalyst (adding amount of the catalyst) was calculated based on the Al atom (weight). Because the molecular weight could not be measured with GPC in Example b21, it was determined in terms of the viscosity average molecular weight (Mv).

### Examples b23 to b24

In a similar manner to Example b1 except that the polymerization catalyst B2, i.e., PMAO-S (a solution of polymethyl aluminoxane in toluene: manufactured by Tosoh Finechem Corporation; Al concentration 7.6% by weight) was used as the polymerization catalyst, and that the amount of the catalyst was as shown in Table 4 below, Examples b23 and Example b24 were performed. Specifications of the catalyst and the like, conditions and results are summarized in Table 4 below. The amount of the catalyst (adding amount of the catalyst) was calculated based on the Al atom (weight).

### Example b25

The polymerization catalyst Z1 was used as the polymerization catalyst, and a catalyst solution of this polymerization catalyst Z1 and ethylene oxide were charged by continuous feeding using the metering pump. Others were similar to those in Example b1. The feeding rate was 0.05 g/min for ethylene oxide, and 0.08 g/min for the catalyst. Charging was conducted over 4 hours. After completing the feeding, the aging reaction was allowed for 1 hour. Accordingly, the reaction time was 5 hours in total. Specifications of the catalyst and the like, conditions and results are summarized in Table 4 below. The amount of the catalyst (adding amount of the catalyst) was calculated based on the Al atom (weight). The molecular weight was determined in terms of the viscosity average molecular weight (Mv).

TABLE 4
Specifications and Evaluation Results of Examples b18 to b25

| | | Catalyst | Catalyst | | | | | |
|---|---|---|---|---|---|---|---|---|
| | | Amount | Amount | Polymerization | Polymerization | Inversion | | |
| Example | Catalyst | (g) | (mmol) | Temperature | Time | Rate | Mn | Mw |
| b18 | Polymerization | 0.10 g | — | 100° C. | 5 hrs | 16% | 3800 | 34300 |
| | Catalyst Y1 | | | | | | | |
| b19 | Polymerization | 1.63 g | 0.9 | 100° C. | 5 hrs | 7% | Mv 118000 | |
| | Catalyst Z1 | | | | | | | |
| b20 | Polymerization | 16.0 g | 9 | 100° C. | 5 hrs | 22% | Mv 348000 | |
| | Catalyst Z1 | | | | | | | |
| b21 | Polymerization | 1.33 g | 0.9 | 100° C. | 5 hrs | 5% | Mv 59000 | |
| | Catalyst A2 | | | | | | | |
| b22 | Polymerization | 13.0 g | 9 | 100° C. | 5 hrs | 29% | 200 | 300 |
| | Catalyst A2 | | | | | | | |
| b23 | PMAO-S | 0.32 g | 0.9 | 100° C. | 5 hrs | 2% | 190 | 3400 |
| b24 | PMAO-S | 3.21 g | 9 | 100° C. | 5 hrs | 16% | 380 | 22100 |

| | | | | | | | |
|---|---|---|---|---|---|---|---|
| b25 | Polymerization | 20.21 g | 9 | 100° C. | 5 hrs | 39% | Mv 287000 |
| | Catalyst Z1 | | | | | | |

* Adding amount of catalyst including Al was calculated based on Al atom (weight), and added.

### Example b26

The polymerization catalyst C2, i.e., a 20.5% by weight solution of diethylzinc in toluene was used as the polymerization catalyst. However, a product generated by a reaction between the 20.5% by weight solution of diethylzinc in toluene and a slight amount of moisture existed in the polymerization system exhibits the catalytic activity. Moreover, the polymerization temperature (reaction temperature) was 30° C., and the polymerize time was 24 hours. Except for these, Example b26 was performed under the conditions that are similar to those in Example b1. Specifications of the catalyst and the like, conditions and results are summarized in Table 5 below.

### Example b27

The polymerization catalyst D2 was used as the polymerization catalyst, with the amount of the catalyst as shown in Table 5 below. The polymerization temperature (reaction temperature) was 30° C. Except for these, Example b27 was performed under the conditions that are similar to those in Example b1. Specifications of the catalyst and the like, conditions and results are summarized in Table 5 below. The amount of the catalyst (adding amount of the catalyst) was calculated based on the Zn atom (weight).

### Example b28

In a similar manner to Example b1 except that the polymerization catalyst D2 was used as the polymerization catalyst, and that the amount of the catalyst was as shown in Table 5 below, Example b28 was performed. Specifications of the catalyst and the like, conditions and results are summarized in Table 5 below. The amount of the catalyst (adding amount of the catalyst) was calculated based on the Zn atom (weight).

### Example b29

In a similar manner to Example b1 except that the polymerization catalyst E2 was used as the polymerization catalyst, and that the amount of the catalyst was as shown in Table 5 below, Example b29 was performed. Specifications of the catalyst and the like, conditions and results are summarized in Table 5 below. The amount of the catalyst (adding amount of the catalyst) was calculated based on the Zn atom (weight).

TABLE 5
Specifications and Evaluation Results of Example b26 to Example b29

| | | Catalyst | Catalyst | | | | | |
|---|---|---|---|---|---|---|---|---|
| | | Amount | Amount | Polymerization | Polymerization | Inversion | | |
| Example | Catalyst | (g) | (mmol) | Temperature | Time | Rate | Mn | Mw |
| b26 | 20.5 wt % Et₂Zn | 0.55 g | 0.9 | 30° C. | 24 hrs | 3% | 160 | 220 |
| b27 | Polymerization | 3.87 g | 0.9 | 30° C. | 5 hrs | 1% | 120 | 170 |
| | Catalyst D2 | | | | | | | |
| b28 | Polymerization | 3.89 g | 0.9 | 100° C. | 5 hrs | 3% | 120 | 3650 |
| | Catalyst D2 | | | | | | | |
| b29 | Polymerization | 6.0 ml | 0.9 | 100° C. | 5 hrs | 2% | 240 | 730 |
| | Catalyst E2 | | | | | | | |

* Adding amount of catalyst was calculated based on Zn atom (weight), and added.

### Examples b30 to b36

As the polymerization catalyst, the aforementioned polymerization catalyst G1, i.e., a solution of potassium t-butoxide in THF (reagent manufactured by Aldrich; 1.0 mol/l) was used. When the catalyst and an acetone solvent were charged, the additive shown in Table 6 was charged. The additive was added in the equivalent number of moles to the catalyst (i.e., 0.9 mmol). As shown in Table 6, 18-crown ether-6 (manufactured by Wako Pure Chemical Industries, Ltd.), 15-crown ether-5 (manufactured by Wako Pure Chemical Industries, Ltd.), 12-crown ether-4 (manufactured by Wako Pure Chemical Industries, Ltd.), tetra-n-butylammonium chloride (manufactured by Tokyo Chemical Industry Co., Ltd.; in Table 6 represented by “(n-Bu)₄NCl”), and polyethylene glycol dimethyl ether having a number average molecular weight Mn of 2000 (manufactured by Aldrich; in Table 6, represented by “dimethoxy PEG”) were used as the additive. Others were similar to those in Example b1. Accordingly, Example b30, Example b31, Example b32, Example b33, Example b34, Example b35 and Example b36 were performed. The amount of the additive, specifications of the catalyst and the like, conditions and results are summarized in Table 6.

TABLE 6
Specifications and Evaluation Results of Example b30 to Example b36

| | | Catalyst | Catalyst | | Additive | | | | | |
|---|---|---|---|---|---|---|---|---|---|---|
| | | Amount | Amount | | Amount | Polymerization | Polymerization | Inversion | | |
| Example | Catalyst | (g) | (mmol) | Additive | (g) | Temperature | Time | Rate | Mn | Mw |
| b30 | KO-t-Bu | 0.82 g | 0.9 | 18-crown ether-6 | 0.23 | 100° C. | 5 hrs | 100% | 200 | 280 |
| b31 | KO-t-Bu | 0.82 g | 0.9 | 18-crown ether-6 | 0.24 | 60° C. | 24 hrs | 89% | 240 | 340 |
| b32 | KO-t-Bu | 0.82 g | 0.9 | 18-crown ether-6 | 0.24 | 30° C. | 24 hrs | 8% | 60 | 160 |
| b33 | KO-t-Bu | 0.82 g | 0.9 | 15-crown ether-5 | 0.19 | 100° C. | 5 hrs | 79% | 250 | 370 |
| b34 | KO-t-Bu | 0.82 g | 0.9 | 12-crown ether-4 | 0.16 | 100° C. | 5 hrs | 36% | 240 | 370 |
| b35 | KO-t-Bu | 0.82 g | 0.9 | (n-Bu)₄NCl | 0.25 | 100° C. | 5 hrs | 100% | 50 | 160 |
| b36 | KO-t-Bu | 0.82 g | 0.9 | Dimethoxy PEG | 1.82 | 100° C. | 5 hrs | 100% | 220 | 300 |

### Example b37

Into a glove box in a dry state consistently by circulation of nitrogen was placed a 100-ml autoclave (manufactured by Taiatsu Techno Corporation). The 100-ml autoclave was dried by circulating dry nitrogen over night or longer. The autoclave has a vessel part for charging the reaction liquid, and a lid part equipped with the agitator and valve, with both parts fastened by hand for use in drying. After the drying, the lid part and the vessel part were detached to carry out the charging operation. After the charging, the autoclave was loosely fastened by hand, which was thereafter removed from the glove box, and additionally fastened by a crescent wrench.

First, into the vessel part of the autoclave was charged 30 g of dehydrated acetone (manufactured by Wako Pure Chemical Industries, Ltd.) as a solvent. Then, 0.82 g of the aforementioned polymerization catalyst G1, i.e., a solution of potassium t-butoxide (0.9 mmol) in THF (reagent manufactured by Aldrich; 1.0 mol/l) was charged as a polymerization catalyst. Further, as a comonomer for the ethylene oxide, 6.60 g of propylene oxide (manufactured by Wako Pure Chemical Industries, Ltd.) was charged.

Next, the inside of the autoclave was replaced with nitrogen three times with a nitrogen cylinder at 0.5 MPa, and thereafter was further compressed again at 0.5 MPa. Subsequently, the vessel part of the autoclave was dipped into a 110° C. oil bath to execute heating. At this time, agitation was started.

The temperature inside of the autoclave of not lower than 95° C. was confirmed, and 5 g of ethylene oxide was fed with a metering pump. When rise in temperature and rise in pressure in the autoclave subsided, 5 g of ethylene oxide was further fed with the metering pump. Thereafter, the temperature of the oil bath was regulated and kept so that the temperature in the autoclave was kept at 100° C. for 5 hours. After this aging reaction for 5 hours, the vessel part of the autoclave was cooled by dipping in a bucket filled with water. Following the confirmation of termination of the cooling to approximately the room temperature, the valve was unfastened to release the internal pressure there by turning back to the ordinary pressure.

Next, the lid part and the vessel part of the autoclave were separated by opening with a crescent wrench. The polymer solution was recovered by repacking into a glass bottle. Inversion rate was 4% as determined from the change in the weight of the residue left after volatilizing the solvent (residual ratio). As a consequence of measuring the molecular weight by GPC, the number average molecular weight (Mn) was 60, and the weight average molecular weight (Mw) was 150. Analysis of the composition ratio of the copolymerized polymer by ¹H-NMR revealed that molar ratio of ethylene oxide: propylene oxide was 62.3:37.7. Type and charging amount of the comonomer, composition of the monomer (weight ratio), specifications of the catalyst and the like, conditions and results are summarized in Table 7 below.

### Example b38 and b39

In a similar manner to Example b37 except that the copolymerization was carried out with the type of the comonomer, the charging amount of the comonomer and the composition of the monomer being changed as described in the following Table 7, Example b38 and Example b39 were performed. Type and charging amount of the comonomer, composition of the monomer (weight ratio), specifications of the catalyst and the like, conditions and results are summarized in Table 7 below.

TABLE 7
Specifications and Evaluation Results of Example b37 to Example b39

| | | Catalyst | Catalyst | Comonomer | Monomer | | | | | |
|---|---|---|---|---|---|---|---|---|---|---|
| | | Amount | Amount | (Type: Charging | Composition | Polymerization | Polymerization | Inversion | | |
| Example | Catalyst | (g) | (mmol) | Amount) | (wt ratio) | Temperature | Time | Rate | Mn | Mw |
| b37 | KO-t-Bu | 0.82 g | 0.9 | PO: 6.60 g | EO/PO = 50/50 | 100° C. | 5 hrs | 4% | 60 | 150 |
| b38 | KO-t-Bu | 0.82 g | 0.9 | BO: 8.18 g | EO/BO = 30/70 | 100° C. | 5 hrs | 4% | 80 | 200 |
| b39 | KO-t-Bu | 0.82 g | 0.9 | BO: 0.82 g | EO/BO = 95/5 | 100° C. | 5 hrs | 91% | 70 | 280 |

### Example b40

Into a glove box in a dry state consistently by circulation of nitrogen was placed a 1-L autoclave (manufactured by Taiatsu Techno Corporation). The 1-L autoclave was dried by circulating dry nitrogen over night or longer. The autoclave has a vessel part for charging the reaction liquid, and a lid part equipped with the agitator and valve, with both parts fastened by hand for use in drying. After the drying, the lid part and the vessel part were detached to carry out the charging operation. After the charging, the autoclave was removed from the glove box, and additionally fastened.

First, into the vessel part of the autoclave was charged 192.0 g of dehydrated acetone (manufactured by Wako Pure Chemical Industries, Ltd.: moisture content 9.9 ppm) as a solvent. Then, 15.11 g of the aforementioned catalyst G1, i.e., a solution of potassium t-butoxide in THF (reagent manufactured by Aldrich; 1.0 mol/l) was charged as a polymerization catalyst. The inside of the autoclave was replaced with nitrogen three times with a nitrogen cylinder at 0.5 MPa, and thereafter was further compressed again at 0.5 MPa. Subsequently, the vessel part of the autoclave was dipped into a 110° C. oil bath to execute heating. At this time, agitation was started.

The temperature inside of the autoclave of not lower than 95° C. was confirmed, and ethylene oxide and butylene oxide were continuously fed with a metering pump for the feeding time period of 5 hours. The feeding rate of ethylene oxide was 0.576 g/min, while the feeding rate of butylene oxide was 0.064 g/min. The end of the feeding of both two kinds of monomers was identified as termination of the polymerization reaction. During the polymerization, the temperature of the oil bath was regulated and kept so that the temperature in the autoclave was kept at 100° C.

After completing the polymerization reaction, the vessel part of the autoclave was cooled by dipping in a bucket filled with water. Following the confirmation of termination of the cooling to approximately the room temperature, the valve was unfastened to release the internal pressure there by turning back to the ordinary pressure.

Next, the lid part and the vessel part of the autoclave were separated by opening. The polymer solution was then recovered by repacking into a glass bottle. Inversion rate was 100% as determined from the change in the weight of the residue left after volatilizing the solvent (residual ratio). As a consequence of measuring the molecular weight by GPC, the number average molecular weight (Mn) was 350, and the weight average molecular weight (Mw) was 600. Analysis of the composition ratio of the copolymerized polymer by ¹H-NMR revealed that molar ratio of ethylene oxide: propylene oxide was 89.5:10.5.

### Example b41

Into a glove box in a dry state consistently by circulation of nitrogen was placed a 1-L autoclave (manufactured by Taiatsu Techno Corporation). The 1-L autoclave was dried by circulating dry nitrogen over night or longer. The autoclave has a vessel part for charging the reaction liquid, and a lid part equipped with the agitator and valve, with both parts fastened by hand for use in drying. After the drying, the lid part and the vessel part were detached to carry out the charging operation. After the charging, the autoclave was removed from the glove box, and additionally fastened.

First, into the vessel part of the autoclave was charged 192.0 g of dehydrated acetone (manufactured by Wako Pure Chemical Industries, Ltd.) as a solvent. Then, 12.29 g of the aforementioned polymerization catalyst Y1 was charged as a polymerization catalyst. The inside of the autoclave was replaced with nitrogen three times with a nitrogen cylinder at 0.5 MPa, and thereafter was further compressed again at 0.5 MPa. Subsequently, the vessel part of the autoclave was dipped into a 110° C. oil bath to execute heating. At this time, agitation was started.

The temperature inside of the autoclave of not lower than 95° C. was confirmed, and ethylene oxide and butylene oxide were continuously fed with a metering pump for the feeding time period of 5 hours. The feeding rate of ethylene oxide was 0.576 g/min, while the feeding rate of butylene oxide was 0.064 g/min. The end of the feeding of both two kinds of monomers was identified as termination of the polymerization reaction. During the polymerization, the temperature of the oil bath was regulated and kept so that the temperature in the autoclave was kept at 100° C.

After completing the polymerization reaction, the vessel part of the autoclave was cooled by dipping in a bucket filled with water. Following the confirmation of termination of the cooling to approximately the room temperature, the valve was unfastened to release the internal pressure there by turning back to the ordinary pressure.

Next, the lid part and the vessel part of the autoclave were separated by opening. The polymer solution was recovered by repacking into a glass bottle. Inversion rate was 33% as determined from the change in the weight of the residue left after volatilizing the solvent (residual ratio). As a consequence of measuring the molecular weight by GPC, the number average molecular weight (Mn) was 1,500, and the weight average molecular weight (Mw) was 14,700. Analysis of the composition ratio of the copolymerized polymer by ¹H-NMR revealed that molar ratio of ethylene oxide: propylene oxide was 96.2:3.8.

### Example b42

Into a glove box in a dry state consistently by circulation of nitrogen was placed a 1-L autoclave (manufactured by Taiatsu Techno Corporation). The 1-L autoclave was dried by circulating dry nitrogen over night or longer. The autoclave has a vessel part for charging the reaction liquid, and a lid part equipped with the agitator and valve, with both parts fastened by hand for use in drying. After the drying, the lid part and the vessel part were detached to carry out the charging operation. After the charging, the autoclave was removed from the glove box, and additionally fastened.

First, into the vessel part of the autoclave was charged 192.0 g of dehydrated acetone (manufactured by Wako Pure Chemical Industries, Ltd.) as a solvent. Then, 28.94 g of the aforementioned polymerization catalyst Z1 was charged as a polymerization catalyst. The inside of the autoclave was replaced with nitrogen three times with a nitrogen cylinder at 0.5 MPa, and thereafter was further compressed again at 0.5 MPa. Subsequently, the vessel part of the autoclave was dipped into a 110° C. oil bath to execute heating. At this time, agitation was started.

The temperature inside of the autoclave of not lower than 95° C. was confirmed, and ethylene oxide and butylene oxide were continuously fed with a metering pump for the feeding time period of 5 hours. The feeding rate of ethylene oxide was 0.576 g/min, while the feeding rate of butylene oxide was 0.064 g/min. The end of the feeding of both two kinds of monomers was identified as termination of the polymerization reaction. During the polymerization, the temperature of the oil bath was regulated and kept so that the temperature in the autoclave was kept at 100° C.

After completing the polymerization reaction, the vessel part of the autoclave was cooled by dipping in a bucket filled with water. Following the confirmation of termination of the cooling to approximately the room temperature, the valve was unfastened to release the internal pressure there by turning back to the ordinary pressure.

Next, the lid part and the vessel part of the autoclave were separated by opening. The polymer solution was recovered by repacking into a glass bottle. Inversion rate was 8% as determined from the change in the weight of the residue left after volatilizing the solvent (residual ratio). As a consequence of determination of the molecular weight by measuring the viscosity, Mv (viscosity average molecular weight) was 44,500. Analysis of the composition ratio of the copolymerized polymer by ¹H-NMR revealed that molar ratio of ethylene oxide: propylene oxide was 96.1:3.9.

### Example b43

Into a glove box in a dry state consistently by circulation of nitrogen was placed a 1-L autoclave (manufactured by Taiatsu Techno Corporation). The 1-L autoclave was dried by circulating dry nitrogen over night or longer. The autoclave has a vessel part for charging the reaction liquid, and a lid part equipped with the agitator and valve, with both parts fastened by hand for use in drying. After the drying, the lid part and the vessel part were detached to carry out the charging operation. After the charging, the autoclave was removed from the glove box, and additionally fastened.

First, into the vessel part of the autoclave was charged 192.0 g of dehydrated acetone (manufactured by Wako Pure Chemical Industries, Ltd.) as a solvent. Then, 5.95 g of the aforementioned polymerization catalyst B2, i.e., PMAO-S (a solution of polymethyl aluminoxane in toluene: manufactured by Tosoh Finechem Corporation; Al concentration 7.6% by weight) was charged as a polymerization catalyst. The inside of the autoclave was replaced with nitrogen three times with a nitrogen cylinder at 0.5 MPa, and thereafter was further compressed again at 0.5 MPa. Subsequently, the vessel part of the autoclave was dipped into a 110° C. oil bath to execute heating. At this time, agitation was started.

The temperature inside of the autoclave of not lower than 95° C. was confirmed, and ethylene oxide and butylene oxide were continuously fed with a metering pump for the feeding time period of 5 hours. The feeding rate of ethylene oxide was 0.576 g/min, while the feeding rate of butylene oxide was 0.064 g/min. The end of the feeding of both two kinds of monomers was identified as termination of the polymerization reaction. During the polymerization, the temperature of the oil bath was regulated and kept so that the temperature in the autoclave was kept at 100° C.

After completing the polymerization reaction, the vessel part of the autoclave was cooled by dipping in a bucket filled with water. Following the confirmation of termination of the cooling to approximately the room temperature, the valve was unfastened to release the internal pressure there by turning back to the ordinary pressure.

Next, the lid part and the vessel part of the autoclave were separated by opening. The polymer solution was recovered by repacking into a glass bottle. Inversion rate was 7% as determined from the change in the weight of the residue left after volatilizing the solvent (residual ratio). As a consequence of measuring the molecular weight by GPC, the number average molecular weight (Mn) was 230, and the weight average molecular weight (Mw) was 460. Analysis of the composition ratio of the copolymerized polymer by ¹H-NMR revealed that molar ratio of ethylene oxide: propylene oxide was 98.4:1.6.

### Example b44

Similar process to Example b1 was performed except that dehydrated 2-butanone (manufactured by Wako Pure Chemical Industries, Ltd.; moisture content 13.4 ppm) was used as the solvent in place of dehydrated acetone.

As a consequence of measuring the molecular weight by GPC, the number average molecular weight (Mn) was 340, and the weight average molecular weight (Mw) was 450.

### Example b45

Similar process to Example b18 was performed except that dehydrated 2-butanone (manufactured by Wako Pure Chemical Industries, Ltd.; moisture content 13.4 ppm) was used as the solvent in place of dehydrated acetone.

As a consequence of measuring the molecular weight by GPC, the number average molecular weight (Mn) was 3,850, and the weight average molecular weight (Mw) was 34,000.

### Example b46

Similar process to Example b19 was performed except that dehydrated 2-butanone (manufactured by Wako Pure Chemical Industries, Ltd.; moisture content 13.4 ppm) was used as the solvent in place of dehydrated acetone.

The molecular weight as determined by measuring the viscosity Mv (viscosity average molecular weight) was 150,000.

### Example b47

Into a glove box in a dry state consistently by circulation of nitrogen was placed a 100-ml autoclave (manufactured by Taiatsu Techno Corporation). The 100-ml autoclave was dried by circulating dry nitrogen over night or longer. The autoclave has a vessel part for charging the reaction liquid, and a lid part equipped with the agitator and valve, with both parts fastened by hand for use in drying. After the drying, the lid part and the vessel part were detached to carry out the charging operation. After the charging, the autoclave was loosely fastened by hand, which was thereafter removed from the glove box, and additionally fastened by a crescent wrench.

First, into the vessel part of the autoclave was charged 30 g of dehydrated acetone (manufactured by Wako Pure Chemical Industries, Ltd.; moisture content 10.9 ppm) as a solvent. Then, 0.1 g of the aforementioned polymerization catalyst Yl was charged as a polymerization catalyst. Further, as a comonomer for the ethylene oxide, allylglycidyl ether (manufactured by Wako Pure Chemical Industries, Ltd.), and diethylene glycol glycidylmethyl ether were charged. The allylglycidyl ether (manufactured by Wako Pure Chemical Industries, Ltd.) was charged in an amount of 0.3 g. The diethylene glycol glycidylmethyl ether was charged in an amount of 2.0 g. The employed diethylene glycol glycidylmethyl ether was a synthesized product from epichlorohydrin and diethylene glycol monomethyl ether.

Next, the inside of the autoclave was replaced with nitrogen three times with a nitrogen cylinder at 0.5 MPa, and thereafter was further compressed again at 0.5 MPa. Subsequently, the vessel part of the autoclave was dipped into a 110° C. oil bath to execute heating. At this time, agitation was started.

The temperature inside of the autoclave of not lower than 95° C. was confirmed, and 5 g of ethylene oxide was fed with a metering pump. When rise in temperature and rise in pressure in the autoclave subsided, 5 g of ethylene oxide was further fed with the metering pump. Thereafter, the temperature of the oil bath was regulated and kept so that the temperature in the autoclave was kept at 100° C. for 5 hours. After the aging reaction for 5 hours, the vessel part of the autoclave was cooled by dipping in a bucket filled with water. Following the confirmation of termination of the cooling to approximately the room temperature, the valve was unfastened to release the internal pressure there by turning back to the ordinary pressure.

Next, the lid part and the vessel part of the autoclave were separated by opening with a crescent wrench. The polymer solution was recovered by repacking into a glass bottle. Inversion rate of the monomer (ethylene oxide) was 14% as determined from the change in the weight of the residue left after volatilizing the solvent (residual ratio). As a consequence of measuring the molecular weight by GPC, the number average molecular weight (Mn) was 3,000, and the weight average molecular weight (Mw) was 31,000.

Diethylene glycol glycidylmethyl ether is represented by the following formula (3).

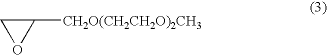

The foregoing description is merely an illustrative example, and various modifications may be made without departing from the principles of the present invention.

What is claimed is:

1. A method for the production of an alkylene oxide based polymer in a process for obtaining an alkylene oxide based polymer by allowing a monomer including one or two or more oxirane compound(s), which may have a substituent, as an essential raw material to be polymerized using a polymerization catalyst while agitating in a solvent, wherein said solvent includes one or two or more compound(s) selected from the group consisting of ketones, ketone derivatives, esters, ethers, nitrile compounds and organic halogen compounds; and the polymerization catalyst has a polymerization activity toward alkylene oxide in the solvent.

2. The method for the production of an alkylene oxide based polymer according to claim 1 wherein said polymerization catalyst comprises one or two or more compound(s) selected from the group consisting of from the following first group to fifth group, i.e., the first group: a group consisting of hydroxides of an element in group IA, alkoxy compounds of an element in group IA, and phenoxy compounds of an element in group IA; the second group: a group consisting of oxides of an element in group IA, group IIA, group IIB, group IVB or group VIII, and carboxylic acid salts of an element in group IA, group IIA, group IIB, group IVB or group VIII; the third group: a group consisting of compounds prepared by allowing a compound represented by R×M (wherein R represents a hydrocarbon group having 1 or more carbon atoms; M represents a metal having a Pauling's electronegativity of 0.5 to 3.0; and x represents the atomic valence of M) to react with a compound having one or more carbon atoms and having active hydrogen, and one or two or more compound(s) selected from the group consisting of water, phosphoric acid compounds, metal halide and Lewis bases; the fourth group: a group consisting of metal halides wherein the metal is Na, Be, Zr, Fe, Zn, Al, Ti, Sn,Ga or Sb; and the fifth group: a group consisting of onium salts of an element in group VB.

3. The method for the production of an alkylene oxide based polymer according to claim 2 wherein said polymerization catalyst comprises one or two or more metal(s) selected from the group consisting of Al, Zn, Sn, P, alkali metals, Ga, Zr and Ti.

4. The method for the production of an alkylene oxide based polymer according to claim 1 wherein said solvent is acetone.

5. The method for the production of an alkylene oxide based polymer according to claim 1 wherein said polymerization catalyst is charged successively.
